(19) United States
(12) Patent Application Publication
(10) Pub. No.: US 2020/0125322 A1
(43) Pub. Date: Apr. 23, 2020

(54) SYSTEMS AND METHODS FOR CUSTOMIZATION OF AUGMENTED REALITY USER INTERFACE

(71) Applicant: Navitaire LLC, Minneapolis, MN (US)

(72) Inventor: Justin Steven WILDE, Salt Lake City, UT (US)

(73) Assignee: Navitaire LLC

(21) Appl. No.: 16/167,407

(22) Filed: Oct. 22, 2018

(51) Int. Cl. G06F 3/16; G06K 9/00; G06F 3/0481; G10L 15/22; G10L 15/18; G06F 16/245; G06F 9/451

(52) U.S. Cl. CPC G06F 3/167; G06K 9/00671; G06F 3/0481; G10L 15/22; G10L 2015/088; G06F 16/245; G06F 9/451; G06K 9/00302; G10L 15/1822

(57) ABSTRACT

Methods, systems, and computer-readable storage media for providing a customizable user interface in a field of view of an augmented reality device of the augmented reality system. The method including accessing a data set including one or more trigger word sequences to populate the user interface based on a person in the field of view of the augmented reality device. The method further capturing audio from the user wearing the augmented reality device of the augmented reality system for determining whether the captured audio includes a trigger word sequence of the one or more trigger word sequence set. When a trigger word sequence from a set exists, the method identifying an action element mapped to the trigger word sequence and updating the user interface based on the identified action element.

### TECHNICAL FIELD

This disclosure relates to customizing a user interface of an augmented reality system. More specifically, this disclosure relates to systems and methods for dynamically refreshing the user interface based on certain conditions.

### BACKGROUND

The increasing availability of data and data sources in the modern world has driven innovation in the ways that people consume data. Individuals increasingly rely on online resources and the availability of data to inform their daily behavior and interactions. The ubiquity of portable, connected devices has allowed for the access of this type of information from almost anywhere.

The use of this information to augment one's view of the physical world, however, remains in its infancy. Current augmented reality systems can overlay visual data on a screen or viewport providing information overlaid onto the visual world. Although useful, these types of systems are usually limited to simply providing an additional display for information already available to a user or replicating the visual spectrum with overlaid data. There is a need for truly augmented systems that use contextual information and details about the visual perception of a user to provide a fully integrated, augmented reality experience.

### SUMMARY

Certain embodiments of the present disclosure include a computer readable medium containing instructions that, when executed by at least one processor, cause the at least one processor to perform certain instructions for providing a user interface in a field of view of an augmented reality device of the augmented reality system, wherein the augmented reality device is worn by a user. The instructions may perform operations to access a data set to populate the user interface based on a person being in the field of view of the augmented reality device, wherein the data set includes one or more trigger word sequences; capture audio from the user of the augmented reality device of the augmented reality system; determine whether the captured audio includes a trigger word sequence of the one or more trigger word sequences; identify an action element mapped to the trigger word sequence based on the determination; and update the user interface based on the identified action element.

Certain embodiments of the present disclosure include a computer readable medium containing instructions that, when executed by at least one processor, cause the at least one processor to perform certain instructions for displaying updated user interface. The instructions may perform operations to determine a first role of a user of an augmented reality device of the augmented reality system; display on the augmented reality device a first set of one or more user interfaces associated with the first role of the user; determine a change in role from the first role to a second role of the user; and update the display to include a second set of one or more user interfaces associated with the second role of the user.

Certain embodiments of the present disclosure include a computer readable medium containing instructions that, when executed by at least one processor, cause the at least one processor to perform certain instructions for filtering external noise. The instructions may perform operations to capture audio that includes audio corresponding to a person in a field of view of an augmented reality device of the augmented reality system; capture video of the person; syncing the captured audio to lip movement of the person in the captured video; and filter audio other than the audio corresponding to the person.

Certain embodiments of the present disclosure include a computer readable medium containing instructions that, when executed by at least one processor, cause the at least one processor to perform certain instructions for providing ability to measure dimensions of an object in field of view. The instructions may perform operations to identify the object in the field of view of an augmented reality device of the augmented reality system; determine if the object is a relevant object to measure; in response to the determination, evaluating the dimensions of the object; and display, in the augmented reality device, information corresponding to the dimensions of the object.

Certain embodiments relate to a computer-implemented method for providing a customizable user interface. The method may include providing a user interface in a field of view of an augmented reality device of the augmented reality system, wherein the augmented reality device is worn by a user; accessing a data set to populate the user interface based on a person being in the field of view of the augmented reality device, wherein the data set includes one or more trigger word sequences; capturing audio from the user of the augmented reality device of the augmented reality system; determining whether the captured audio includes a trigger word sequence of the one or more trigger word sequences; identifying an action element mapped to the trigger word sequence based on the determination; and updating the user interface based on the identified action element.

Certain embodiments of the present disclosure relate to an augmented reality system for providing a user interface in a field of view of an augmented reality device of the augmented reality system, wherein the augmented reality device is worn by a user. The augmented reality system comprising at least one processor configured to: access a data set to populate the user interface based on a person being in the field of view of the augmented reality device, wherein the data set includes one or more trigger word sequences; capture audio from the user of the augmented reality device of the augmented reality system; determine whether the captured audio includes a trigger word sequence of the one or more trigger word sequences; identify an action element mapped to the trigger word sequence based on the determination; and update the user interface based on the identified action element.

Certain embodiments of the present disclosure relate to an augmented reality system displaying updated user interface. The augmented reality system comprising at least one processor configured to: determine a first role of a user of an augmented reality device of the augmented reality system; display on the augmented reality device a first set of one or more user interfaces associated with the first role of the user; determine a change in role from the first role to a second role of the user; and update the display to include a second set of one or more user interfaces associated with the second role of the user.

Certain embodiments of the present disclosure relate to an augmented reality system filtering external noise. The augmented reality system comprising at least one processor configured to: capture audio that includes audio corresponding to a person in a field of view of an augmented reality device of the augmented reality system; capture video of the person; syncing the captured audio to lip movement of the person in the captured video; and filter audio other than the audio corresponding to the person.

Certain embodiments of the present disclosure relate to an augmented reality system providing ability to measure dimensions of an object in field of view. The augmented reality system comprising at least one processor configured to: identify the object in the field of view of an augmented reality device of the augmented reality system; determine if the object is a relevant object to measure; in response to the determination, evaluating the dimensions of the object; and display, in the augmented reality device, information corresponding to the dimensions of the object.

Certain embodiments relate to a computer-implemented method for displaying updated user interface. The method may include determining a first role of a user of an augmented reality device of the augmented reality system; displaying on the augmented reality device a first set of one or more user interfaces associated with the first role of the user; determining a change in role from the first role to a second role of the user; and updating the display to include a second set of one or more user interfaces associated with the second role of the user.

Certain embodiments relate to a computer-implemented method for filtering external noise. The method may include capturing audio that includes audio corresponding to a person in a field of view of an augmented reality device of the augmented reality system; capturing video of the person; syncing the captured audio to lip movement of the person in the captured video; and filtering audio other than the audio corresponding to the person.

Certain embodiments relate to a computer-implemented method for providing ability to measure dimensions of an object in field of view. The method may include identifying the object in the field of view of an augmented reality device of the augmented reality system; determining if the object is a relevant object to measure; in response to the determination, evaluating the dimensions of the object; and displaying, in the augmented reality device, information corresponding to the dimensions of the object.

### BRIEF DESCRIPTION OF THE DRAWINGS

Reference will now be made to the accompanying drawings showing example embodiments of this disclosure. In the drawings:

FIG. 1 is a block diagram of an exemplary system for an integrated augmented reality system, consistent with embodiments of the present disclosure.

FIG. 2 is a block diagram of an exemplary computing device, consistent with embodiments of the present disclosure.

FIGS. 3A and 3B are diagrams of exemplary augmented reality devices, consistent with embodiments of the present disclosure.

FIG. 4 is a block diagram of an exemplary augmented reality system, consistent with embodiments of the present disclosure

FIGS. 5A and 5B are diagrams of exemplary user interfaces of augmented reality devices, consistent with embodiments of the present disclosure.

FIGS. 6A-6C are diagrams of exemplary interactions with persons in a field of view of augmented reality devices to update user interfaces, consistent with embodiments of the present disclosure.

FIG. 7 is a diagrams of exemplary user interfaces of augmented reality devices based on auxiliary information, consistent with the present disclosure.

FIGS. 8A and 8B are diagrams of exemplary user interface to utilize augmented reality device as a tool, consistent with the embodiments of the present disclosure.

FIGS. 9A and 9B are diagrams of exemplary user interfaces to scan items using augmented reality devices, consistent with the present disclosure.

FIG. 10 is an exemplary customized user interface 1000 displaying read only information, consistent with the embodiments of the current disclosure.

FIG. 11 is a flowchart of an exemplary method for dynamic customization of a user interface of augmented reality systems, consistent with embodiments of the present disclosure.

FIG. 12 is a flowchart of an exemplary method for filtering external noises during interaction with augmented reality systems, consistent with embodiments of the present disclosure.

FIG. 13 is a flowchart of an exemplary method for dynamic display of information in augmented reality systems, consistent with embodiments of the present disclosure.

FIG. 14 is a flowchart of an exemplary method for determination of dimensions of an object using augmented reality systems, consistent with embodiments and of the present disclosure.

### DETAILED DESCRIPTION

Reference will now be made in detail to the exemplary embodiments implemented according to the present disclosure, examples of which are illustrated in the accompanying drawings. Wherever possible, the same reference numbers will be used throughout the drawings to refer to the same or like parts.

The embodiments described herein relate to improved interaction and integration in augmented reality systems. Augmented reality systems provide vast potential for enhancing visual understanding of the world at large. By complementing the visual perspective individuals experience with their eyes, augmented reality systems can provide a more detailed understanding of the world around us.

Current augmented reality systems can overlay computer-generated images and data on a visual field of view providing a visual experience not available with eyes alone. Current implementations, however, of augmented reality systems fail to provide a fully integrated experience. The visual overlay typically relates to things like notifications or alerts. In these systems, although the augmented reality experience provides a useful application, the augmentation is unrelated to the visual focus of the user. In other augmented reality systems, the graphical overlay provides information about objects the user is viewing, but the provided information is limited to that particular application and data set.

The embodiments described herein approach these problems from a different perspective. Instead of focusing on providing a limited set of information based on a particular application, the disclosed systems integrate data from the augmented reality device itself with a plethora of data sources associated with the individual. The disclosed systems can further analyze and process the available data using contextual information about the user. The result of this data integration can be provided to the user's augmented reality device to provide a comprehensive overlay of information about seemingly unrelated aspects of the user's visual field of view.

Moreover, the disclosed system and methods can tailor that information based on the contextual information about the individual. The provided overlay can link to other data sources managed by the individual or other parties to provide time, location, and context specific data related to items the individual is viewing.

For example, the system can recognize, based on location information from the augmented reality device or a user's mobile device that the user has arrived at an airport terminal. Using data from the user's digital calendar, along with data about the individual from a travel app hosted by an airline or other travel conveyor, along with other travel software, the disclosed systems and methods can further determine that the individual has an upcoming flight. Upon the individual's arrival, the disclosed system and method can use available information about the upcoming flight and the present check-in status of the individual to direct the individual to the appropriate check-in kiosk, customer service desk, ticketing counter, or boarding gate. Instead of simply providing augmented information about every ticketing counter, as is typical in current augmented reality systems, the disclosed system's integration of data from multiple data sources provides a tailored experience to the individual while also providing the present state of their reservation transaction with the airline or other travel conveyor.

Additionally, the disclosed system and methods can modernize current airport procedures. For example, in the previously described example, the described augmented reality systems can be used to detect where in the airport an individual is, the number of bags they may have, and where they may need to go. This information can be used by the travel systems to manage flight manifests, automatically check-in users, effectively indicate where checked baggage should be placed, automatically generate baggage tags, and provide boarding notifications. In this way, not only are the disclosed systems and methods helpful to the traveler, but they can also enhance the efficiency and effectiveness of airport operations by providing enhanced information that is used to make important decisions about flight and travel management.

Moreover, the disclosed system and methods can provide interactive experiences to the individual. The majority of current augmented reality systems simply disseminate information. Systems that do provide some level of interactivity do so based on a user's interaction with a particular application, limiting the usefulness. Because the disclosed system and methods provide integrated data tailored specifically to the individual, interaction from the individual can relate to any number activities or services associated with the individual. For example, as an individual waits at a gate to board an aircraft, information related to the individual's flight can not only be used to provide status updates, but can also be integrated with the individual's general flight preferences, purchase preferences, or predictive purchasing analysis of the individual to provide detailed information about, among other things, additional seat availability, upgrade options, in-flight amenities, or pre-flight services. The individual can interact with the augmented reality system to change their seat or pre-select in-flight entertainment. Instead of requiring the individual to explicitly request this type of information, the integration provided by the disclosed system and methods allows the system and methods to preemptively provide relevant, useful information to the individual based on contextual information not available from the augmented reality device itself.

The embodiments described herein provide technologies and techniques for using vast amounts of available data (from a variety of data sources) to provide an integrated and interactive augmented reality experience. Embodiments described herein include systems and methods for obtaining contextual information about an individual and device information about an augmented reality device associated with the individual from the augmented reality device. The systems and methods further include obtaining a plurality of data sets associated with the individual or augmented reality device from a plurality of data sources and determining a subset of information from the plurality of data sets relevant to the individual wherein the relevancy of the information is based on the contextual information and the device information obtained from the augmented reality device. Moreover, the embodiments described include systems and methods for generating display data based on the determined subset of information; and providing the display data to the augmented reality device for display on the augmented reality device wherein the display data is overlaid on top of the individual's field of view

In some embodiments, the technologies described further include systems and methods wherein the contextual information obtained from the augmented reality device includes visual data representative of the individual's field of view and wherein the relevancy of the subset of information is further based on an analysis of the visual data. Yet another of the disclosed embodiments includes systems and methods wherein the contextual information obtained from the augmented reality device includes at least one of location information, orientation information, and motion information. In other disclosed embodiments, systems and methods are provided wherein information obtained from the plurality of data sets (in this case the data is coming from proprietary data sources and from the device) includes travel information associated with the individual and wherein the travel information includes at least one of a user profile, travel preferences, purchased travel services, travel updates, and historical travel information.

Additional embodiments consistent with the present disclosure include systems and methods wherein the analysis of the contextual information and device information includes determining entities within the field of view of the individual and filtering information not associated with the entities

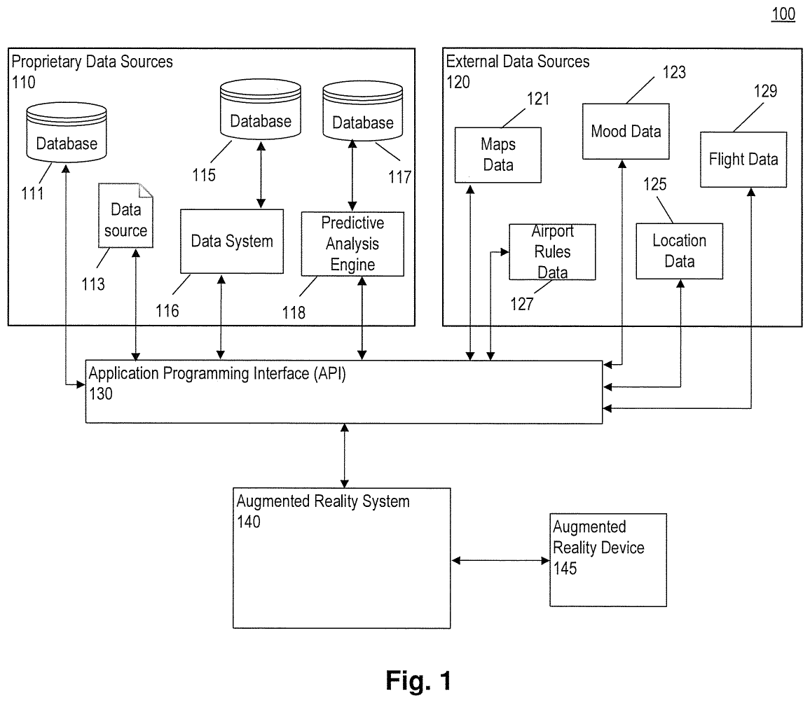

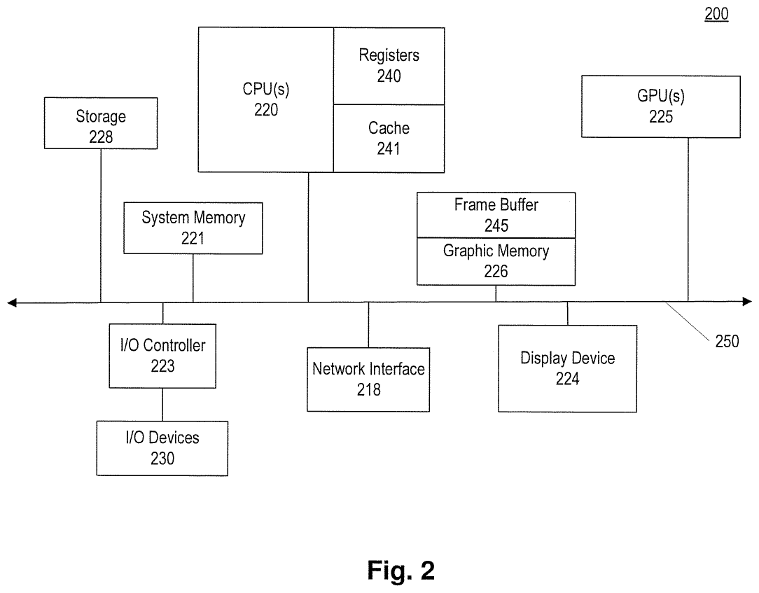

FIG. 1 is a block diagram of an exemplary system 100 for an integrated augmented reality system, consistent with embodiments of the present disclosure. System 100 can include proprietary data sources 110 that include database 111, data source 113, database 115, database 117, data system 116, and predictive analysis engine 118. System 100 can further include external data sources 120 that can include maps data 121, mood data 123, airport rules data 127, flight data 129, and location data 125. System 100 can further include an application programming interface (API) 130. API 130 can be implemented on a server or computer system using, for example, a computing device 200, described in more detail below in reference to FIG. 2. For example, data from proprietary data sources 110 and external data sources 120 can be obtained through I/O devices 230 or a network interface 218 of computing device 200. Further, the data can be stored during processing in a suitable storage such as a storage 228 or system memory 221. Referring back to FIG. 1, system 100 can further include augmented reality system 140. Like API 130, augmented reality system 140 can be implemented on a server or computer system using, for example, computing device 200.

FIG. 2 is a block diagram of an exemplary computing device 200, consistent with embodiments of the present disclosure. In some embodiments, computing device 200 can be a specialized server providing the functionality described herein. In some embodiments, components of system 100, such as proprietary data sources 110 (e.g., database 111, data source 113, database 115, data system 116, database 117, and predictive analysis engine 118), API 130, augmented reality system 140, and augmented virtual reality device 145) can be implemented using computing device 200 or multiple computing devices 200 operating in parallel. Further, computing device 200 can be a second device providing the functionality described herein or receiving information from a server to provide at least some of the described functionality. Moreover, computing device 200 can be an additional device or devices that store or provide data consistent with embodiments of the present disclosure.

Computing device 200 can include one or more central processing units (CPUs) 220 and a system memory 221. Computing device 200 can also include one or more graphics processing units (GPUs) 225 and graphic memory 226. In some embodiments, computing device 200 can be a headless computing device that does not include GPU(s) 225 or graphic memory 226.

CPUs 220 can be single or multiple microprocessors, field-programmable gate arrays, or digital signal processors capable of executing sets of instructions stored in a memory (e.g., system memory 221), a cache (e.g., cache 241), or a register (e.g., one of registers 240). CPUs 220 can contain one or more registers (e.g., registers 240) for storing variable types of data including, inter alia, data, instructions, floating point values, conditional values, memory addresses for locations in memory (e.g., system memory 221 or graphic memory 226), pointers and counters. CPU registers 240 can include special purpose registers used to store data associated with executing instructions such as an instruction pointer, an instruction counter, or memory stack pointer. System memory 221 can include a tangible or a non-transitory computer-readable medium, such as a flexible disk, a hard disk, a compact disk read-only memory (CD-ROM), magneto-optical (MO) drive, digital versatile disk random-access memory (DVD-RAM), a solid-state disk (SSD), a flash drive or flash memory, processor cache, memory register, or a semiconductor memory. System memory 221 can be one or more memory chips capable of storing data and allowing direct access by CPUs 220. System memory 221 can be any type of random access memory (RAM), or other available memory chip capable of operating as described herein.

CPUs 220 can communicate with system memory 221 via a system interface 250, sometimes referred to as a bus. In embodiments that include GPUs 225, GPUs 225 can be any type of specialized circuitry that can manipulate and alter memory (e.g., graphic memory 226) to provide or accelerate the creation of images. GPUs 225 can store images in a frame buffer (e.g., a frame buffer 245) for output to a display device such as display device 224. In some embodiments, images stored in frame buffer 245 can be provided to other computing devices through network interface 218 or I/O devices 230. GPUs 225 can have a highly parallel structure optimized for processing large, parallel blocks of graphical data more efficiently than general purpose CPUs 220. Furthermore, the functionality of GPUs 225 can be included in a chipset of a special purpose processing unit or a co-processor.

CPUs 220 can execute programming instructions stored in system memory 221 or other memory, operate on data stored in memory (e.g., system memory 221) and communicate with GPUs 225 through the system interface 250, which bridges communication between the various components of computing device 200. In some embodiments, CPUs 220, GPUs 225, system interface 250, or any combination thereof, are integrated into a single chipset or processing unit. GPUs 225 can execute sets of instructions stored in memory (e.g., system memory 221), to manipulate graphical data stored in system memory 221 or graphic memory 226. For example, CPUs 220 can provide instructions to GPUs 225, and GPUs 225 can process the instructions to render graphics data stored in the graphic memory 226. Graphic memory 226 can be any memory space accessible by GPUs 225, including local memory, system memory, on-chip memories, and hard disk. GPUs 225 can enable displaying of graphical data stored in graphic memory 226 on display device 224 or can process graphical information and provide that information to connected devices through network interface 218 or I/O devices 230.

Computing device 200 can include display device 224 and input/output (I/O) devices 230 (e.g., a keyboard, a mouse, or a pointing device) connected to I/O controller 223. I/O controller 223 can communicate with the other components of computing device 200 via system interface 250. It should now be appreciated that CPUs 220 can also communicate with system memory 221 and other devices in manners other than through system interface 250, such as through serial communication or direct point-to-point communication. Similarly, GPUs 225 can communicate with graphic memory 226 and other devices in ways other than system interface 250. In addition to receiving input, CPUs 220 can provide output via I/O devices 230 (e.g., through a printer, speakers, bone conduction, or other output devices).

Furthermore, computing device 200 can include a network interface 218 to interface to a LAN, WAN, MAN, or the Internet through a variety of connections including, but not limited to, standard telephone lines, LAN or WAN links (e.g., 802.21, T1, T3, 56 kb, X.25), broadband connections (e.g., ISDN, Frame Relay, ATM), wireless connections (e.g., those conforming to, among others, the 802.11a, 802.11b, 802.11b/g/n, 802.11ac, Bluetooth, Bluetooth LTE, 3GPP, or WiMax standards), or some combination of any or all of the above. Network interface 218 can comprise a built-in network adapter, network interface card, PCMCIA network card, card bus network adapter, wireless network adapter, USB network adapter, modem or any other device suitable for interfacing computing device 200 to any type of network capable of communication and performing the operations described herein.

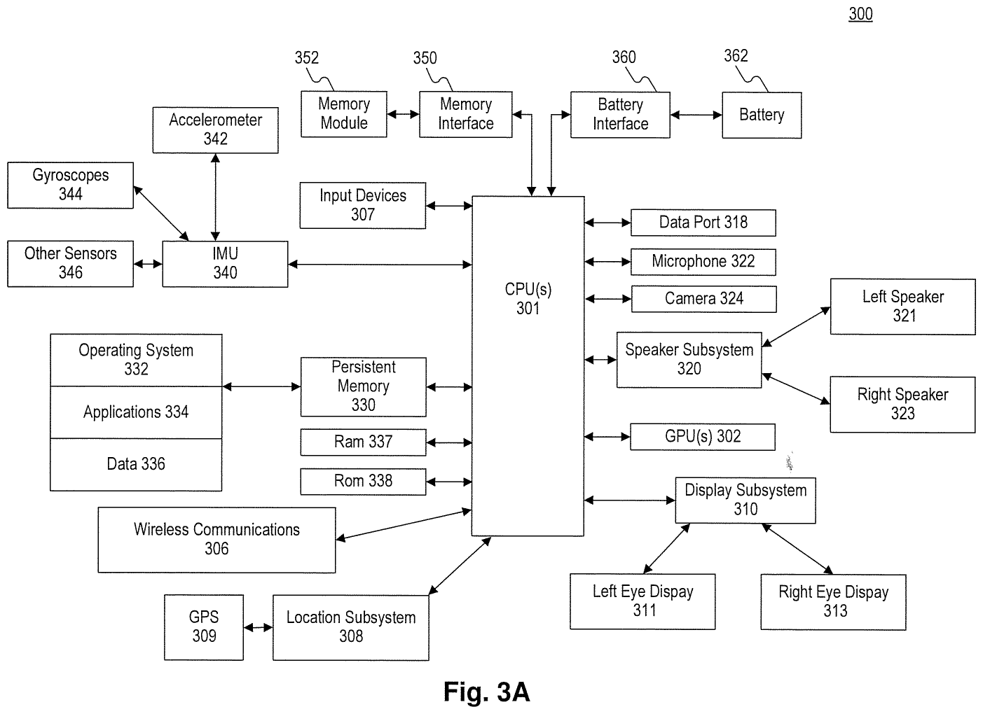

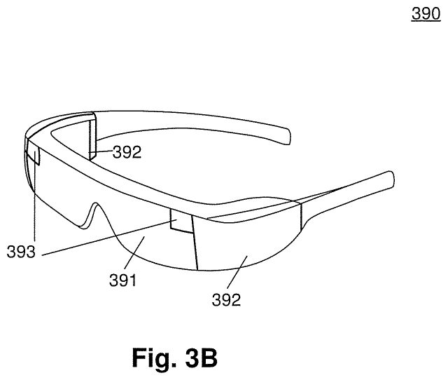

Referring back to FIG. 1, system 100 can further include augmented reality device 145. Augmented reality device can be a device such as augmented reality device 390 depicted in FIG. 3B, described in more detail below, or some other augmented reality device. Moreover, augmented reality device 145 can be implemented using the components shown in device 300 shown in FIG. 3A, described in more detail below.

FIGS. 3A and 3B are diagrams of exemplary augmented reality devices including electronic device 300 and augmented reality device 390, consistent with embodiments of the present disclosure. These exemplary augmented reality devices can represent the internal components (e.g., as shown in FIG. 3A) of an augmented reality device and the external components (e.g., as show in FIG. 3B) of an augmented reality device. In some embodiments, FIG. 3A can represent exemplary electronic device 300 contained within augmented reality device 390 of FIG. 3B.

FIG. 3A is a simplified block diagram illustrating exemplary electronic device 300. In some embodiments, electronic device 300 can include an augmented reality device having video display capabilities and the capability to communicate with other computer systems, for example, via the Internet. Depending on the functionality provided by electronic device 300, in various embodiments, electronic device 300 can be or can include a handheld device, a multiple-mode communication device configured for both data and voice communication, a smartphone, a mobile telephone, a laptop, a computer wired to the network, a netbook, a gaming console, a tablet, a smart watch, eye glasses, a headset, goggles, or a PDA enabled for networked communication.

Electronic device 300 can include a case (not shown) housing component of electronic device 300. The internal components of electronic device 300 can, for example, be constructed on a printed circuit board (PCB). Although the components and subsystems of electronic device 300 can be realized as discrete elements, the functions of the components and subsystems can also be realized by integrating, combining, or packaging one or more elements together in one or more combinations.

Electronic device 300 can include a controller comprising one or more CPU(s) 301, which controls the overall operation of electronic device 300. CPU(s) 301 can be one or more microprocessors, field programmable gate arrays (FPGAs), digital signal processors (DSPs), or any combination thereof capable of executing particular sets of instructions. CPU(s) 301 can interact with device subsystems such as a wireless communication system 306 (which can employ any appropriate wireless (e.g., RF), optical, or other short range communications technology (for example, WiFi, Bluetooth or NFC)) for exchanging radio frequency signals with a wireless network to perform communication functions, an audio subsystem 320 for producing audio, location subsystem 308 for acquiring location information, and a display subsystem 310 for producing display elements. Audio subsystem 320 can transmit audio signals for playback to left speaker 321 and right speaker 323. The audio signal can be either an analog or a digital signal.

CPU(s) 301 can also interact with input devices 307, a persistent memory 330, a random access memory (RAM) 337, a read only memory (ROM) 338, a data port 318 (e.g., a conventional serial data port, a Universal Serial Bus (USB) data port, a 30-pin data port, a Lightning data port, or a High-Definition Multimedia Interface (HDMI) data port), a microphone 322, camera 324, and wireless communication system 306. Some of the subsystems shown in FIG. 3 perform communication-related functions, whereas other subsystems can provide “resident” or on-device functions.

Wireless communication system 306 includes communication systems for communicating with a network to enable communication with any external devices (e.g., a server, not shown). The particular design of wireless communication system 306 depends on the wireless network in which electronic device 300 is intended to operate. Electronic device 300 can send and receive communication signals over the wireless network after the required network registration or activation procedures have been completed.

Location subsystem 308 can provide various systems such as a global positioning system (e.g., a GPS 309) that provides location information. Additionally, location subsystem can utilize location information from connected devices (e.g., connected through wireless communication system 306) to further provide location data. The location information provided by location subsystem 308 can be stored in, for example, persistent memory 330, and used by applications 334 and an operating system 332.

Display subsystem 310 can control various displays (e.g., a left eye display 311 and a right eye display 313). In order to provide an augmented reality display, display subsystem 310 can provide for the display of graphical elements (e.g., those generated using GPU(s) 302) on transparent displays. In other embodiments, the display generated on left eye display 311 and right eye display 313 can include an image captured by camera 324 and reproduced with overlaid graphical elements. Moreover, display subsystem 310 can display different overlays on left eye display 311 and right eye display 313 to show different elements or to provide a simulation of depth or perspective.

Camera 324 can be a CMOS camera, a CCD camera, or any other type of camera capable of capturing and outputting compressed or uncompressed image data such as still images or video image data. In some embodiments, electronic device 300 can include more than one camera, allowing the user to switch, from one camera to another, or to overlay image data captured by one camera on top of image data captured by another camera. Image data output from camera 324 can be stored in, for example, an image buffer, which can be a temporary buffer residing in RAM 337, or a permanent buffer residing in ROM 338 or persistent memory 330. The image buffer can be, for example, a first-in first-out (FIFO) buffer. In some embodiments the image buffer can be provided directly to GPU(s) 302 and display subsystem 310 for display on left eye display 311 or right eye display 313 with or without a graphical overlay.

Electronic device 300 can include an inertial measurement unit (e.g., IMU 340) for measuring motion and orientation data associated with electronic device 300. IMU 340 can utilize an accelerometer 342, gyroscopes 344, and other sensors 346 to capture specific force, angular rate, magnetic fields, and biometric information for use by electronic device 300. The data capture by IMU 340 and the associated sensors (e.g., accelerometer 342, gyroscopes 344, and other sensors 346) can be stored in memory such as persistent memory 330 or RAM 337 and used by applications 334 and operating system 332. The data gathered through IMU 340 and its associated sensors can also be provided to networked devices through, for example, wireless communication system 306.

CPU(s) 301 can be one or more processors that operate under stored program control and executes software modules stored in a tangibly-embodied non-transitory computer-readable storage medium such as persistent memory 330, which can be a register, a processor cache, a Random Access Memory (RAM), a flexible disk, a hard disk, a CD-ROM (compact disk-read only memory), and MO (magneto-optical), a DVD-ROM (digital versatile disk-read only memory), a DVD RAM (digital versatile disk-random access memory), or other semiconductor memories.

Software modules can also be stored in a computer-readable storage medium such as ROM 338, or any appropriate persistent memory technology, including EEPROM, EAROM, FLASH. These computer-readable storage mediums store computer-readable instructions for execution by CPU(s) 301 to perform a variety of functions on electronic device 300. Alternatively, functions and methods can also be implemented in hardware components or combinations of hardware and software such as, for example, ASICs or special purpose computers.

The software modules can include operating system software 332, used to control operation of electronic device 300. Additionally, the software modules can include software applications 334 for providing additional functionality to electronic device 300. For example, software applications 334 can include applications designed to interface with systems like system 100 above. Applications 334 can provide specific functionality to allow electronic device 300 to interface with different data systems and to provide enhanced functionality and visual augmentation.

Software applications 334 can also include a range of applications, including, for example, an e-mail messaging application, an address book, a notepad application, an Internet browser application, a voice communication (i.e., telephony or Voice over Internet Protocol (VoIP)) application, a mapping application, a media player application, a health-related application, etc. Each of software applications 334 can include layout information defining the placement of particular fields and graphic elements intended for display on the augmented reality display (e.g., through display subsystem 310) according to that corresponding application. In some embodiments, software applications 334 are software modules executing under the direction of operating system 332. In some embodiments, the software applications 334 can also include audible sounds and instructions to be played through the augmented reality device speaker system (e.g., through left 321 and right speakers 323 of speaker subsystem 320).

Operating system 332 can provide a number of application protocol interfaces (APIs) providing an interface for communicating between the various subsystems and services of electronic device 300, and software applications 334. For example, operating system software 332 provides a graphics API to applications that need to create graphical elements for display on electronic device 300. Accessing the user interface API can provide the application with the functionality to create and manage augmented interface controls, such as overlays; receive input via camera 324, microphone 322, or input device 307; and other functionality intended for display through display subsystem 310. Furthermore, a camera service API can allow for the capture of video through camera 324 for purposes of capturing image data such as an image or video data that can be processed and used for providing augmentation through display subsystem 310. Additionally, a sound API can deliver verbal instructions for the user to follow, sound effects seeking the user's attention, success or failure in processing certain input, music for entertainment, or to indicate wait time to process a request submitted by the user of the device. The sound API allows for configuration of the system to deliver different music, sounds and instructions based on the user and other contextual information. The audio feedback generated by calling sound API is transmitted

In some embodiments, the components of electronic device 300 can be used together to provide input from the user to electronic device 300. For example, display subsystem 310 can include interactive controls on left eye display 311 and right eye display 313. As part of the augmented display, these controls can appear in front of the user of electronic device 300. Using camera 324, electronic device 300 can detect when a user selects one of the controls displayed on the augmented reality device. The user can select a control by making a particular gesture or movement captured by the camera, touching the area of space where display subsystem 310 displays the virtual control on the augmented view, or by physically touching input device 307 on electronic device 300. This input can be processed by electronic device 300. In some embodiments, a user can select a virtual control by gazing at said control, with eye movement captured by eye tracking sensors (e.g., other sensors 346) of the augmented reality device. A user gazing at a control may be considered a selection if the eyes do not move or have very little movement for a defined period of time. In some embodiments, a user can select a control by placing a virtual dot by moving the augmented reality device worn by the user by moving the head and tracked by gyroscopes sensor 344. The selection can be achieved by placing the dot on a certain control for a pre-defined period of time or by using a handheld input device (e.g., input devices 307) connected to the augmented reality device 300, or by performing a hand gesture.

Camera 324 can further include multiple cameras to detect both direct user input as well as be used for head tracking and hand tracking. As a user moves their head and hands, camera 324 can provide visual information corresponding to the moving environment and movements of the user's hands. These movements can be provided to CPU(s) 301, operating system 332, and applications 334 where the data can be combined with other sensor data and information related to the augmented information displayed through display subsystem 310 to determine user selections and input.

Moreover, electronic device 300 can receive direct input from microphone 322. In some embodiments, microphone 322 can be one or more microphones used for the same or different purposes. For example, in multi-microphone environments some microphones can detect environmental changes while other microphones can receive direct audio commands from the user. Microphone 322 can directly record audio or input from the user. Similar to the visual data from camera 324, audio data from microphone 322 can be provided to CPU(s) 301, operating system 332, and applications 334 for processing to determine the user's input.

In some embodiments, persistent memory 330 stores data 336, including data specific to a user of electronic device 300, such as information of user accounts or device specific identifiers. Persistent memory 330 can also store data (e.g., contents, notifications, and messages) obtained from services accessed by electronic device 300. Persistent memory 330 can further store data relating to various applications with preferences of the particular user of, for example, electronic device 300. In some embodiments, persistent memory 330 can store data 336 linking a user's data with a particular field of data in an application, such as for automatically providing a user's credentials to an application executing on electronic device 300. Furthermore, in various embodiments, data 336 can also include service data comprising information required by electronic device 300 to establish and maintain communication with a network.

In some embodiments, electronic device 300 can also include one or more removable memory modules 352 (e.g., FLASH memory) and a memory interface 350. Removable memory module 352 can store information used to identify or authenticate a user or the user's account to a wireless network. For example, in conjunction with certain types of wireless networks, including GSM and successor networks, removable memory module 352 is referred to as a Subscriber Identity Module (SIM). Memory module 352 can be inserted in or coupled to memory module interface 350 of electronic device 300 in order to operate in conjunction with the wireless network.

Electronic device 300 can also include a battery 362, which furnishes energy for operating electronic device 300. Battery 362 can be coupled to the electrical circuitry of electronic device 300 through a battery interface 360, which can manage such functions as charging battery 362 from an external power source (not shown) and the distribution of energy to various loads within or coupled to electronic device 300.

A set of applications that control basic device operations, including data and possibly voice communication applications, can be installed on electronic device 300 during or after manufacture. Additional applications or upgrades to operating system software 332 or software applications 334 can also be loaded onto electronic device 300 through data port 318, wireless communication system 306, memory module 352, or other suitable system. The downloaded programs or code modules can be permanently installed, for example, written into the persistent memory 330, or written into and executed from RAM 337 for execution by CPU(s) 301 at runtime.

FIG. 3B is an exemplary augmented reality device 390. In some embodiments, augmented reality device 390 can be contact lenses, glasses, goggles, or headgear that provides an augmented viewport for the wearer. In other embodiments (not shown in FIG. 3B) the augmented reality device can be part of a computer, mobile device, portable telecommunications device, tablet, PDA, or other computing device as described in relation to FIG. 3A. Augmented reality device 390 corresponds to augmented reality device 145 shown in FIG. 1.

As shown in FIG. 3B, augmented reality device 390 can include a viewport 391 that the wearer can look through. Augmented reality device 390 can also include processing components 392. Processing components 392 can be enclosures that house the processing hardware and components described above in relation to FIG. 3A. Although shown as two distinct elements on each side of augmented reality device 390, the processing hardware or components can be housed in only one side of augmented reality device 390. The components shown in FIG. 3A can be included in any part of augmented reality device 390.

In some embodiments, augmented reality device 390 can include display devices 393. These display devices can be associated with left eye display 311 and right eye display 313 of FIG. 3A. In these embodiments, display devices 393 can receive the appropriate display information from left eye display 311, right eye display 313, and display subsystem 310, and project or display the appropriate overlay onto viewport 391. Through this process, augmented display device 390 can provide augmented graphical elements to be shown in the wearer's field of view.

Referring back to FIG. 1, each of databases 111, 115, and 117, data source 113, data system 116, predictive analysis engine 118, API 130, and augmented reality system 140 can be a module, which is a packaged functional hardware unit designed for use with other components or a part of a program that performs a particular function of related functions. Each of these modules can be implemented using computing device 200 of FIG. 2. Each of these components is described in more detail below. In some embodiments, the functionality of system 100 can be split across multiple computing devices (e.g., multiple devices similar to computing device 200) to allow for distributed processing of the data. In these embodiments the different components can communicate over I/O device 230 or network interface 218 of computing device 200.

Data can be made available to system 100 through proprietary data sources 110 and external data sources 120. It will now be appreciated that the exemplary data sources shown for each (e.g., databases 111, 115, and 117, data source 113, data system 116, and predictive analysis engine 118 of proprietary data sources 110 and maps data 121, mood data 123, airport rules data 127, flight data 129, and location data 125 of external data sources 120) are not exhaustive. Many different data sources and types of data can exist in both proprietary data sources 110 and external data sources 120. Moreover, some of the data can overlap among external data sources 120 and proprietary data sources 110. For example, external data sources 120 can provide location data 125, which can include data about specific airports or businesses. This same data can also be included, in the same or a different form, in, for example, database 111 of proprietary data sources 110.

Moreover, any of the data sources in proprietary data sources 110 and external data sources 120, or any other data sources used by system 100, can be a Relational Database Management System (RDBMS) (e.g., Oracle Database, Microsoft SQL Server, MySQL, PostgreSQL, or IBM DB2). An RDBMS can be designed to efficiently return data for an entire row, or record, in as few operations as possible. An RDBMS can store data by serializing each row of data. For example, in an RDBMS, data associated with a record can be stored serially such that data associated with all categories of the record can be accessed in one operation. Moreover, an RDBMS can efficiently allow access of related records stored in disparate tables by joining the records on common fields or attributes.

In some embodiments, any of the data sources in proprietary data sources 110 and external data sources 120, or any other data sources used by system 100, can be a non-relational database management system (NRDBMS) (e.g., XML, Cassandra, CouchDB, MongoDB, Oracle NoSQL Database, FoundationDB, or Redis). A non-relational database management system can store data using a variety of data structures such as, among others, a key-value store, a document store, a graph, and a tuple store. For example, a non-relational database using a document store could combine all of the data associated with a particular record into a single document encoded using XML. A non-relational database can provide efficient access of an entire record and provide for effective distribution across multiple data systems.

In some embodiments, any of the data sources in proprietary data sources 110 and external data sources 120, or any other data sources used by system 100, can be a graph database (e.g., Neo4j or Titan). A graph database can store data using graph concepts such as nodes, edges, and properties to represent data. Records stored in a graph database can be associated with other records based on edges that connect the various nodes. These types of databases can efficiently store complex hierarchical relationships that are difficult to model in other types of database systems.

In some embodiments, any of the data sources in proprietary data sources 110 and external data sources 120, or any other data sources used by system 100, can be accessed through an API. For example, data system 116 could be an API that allows access to the data in database 115. Moreover, external data sources 120 can all be publicly available data accessed through an API. API 130 can access any of the data sources through their specific API to provide additional data and information to system 100.

Although the data sources of proprietary data sources 110 and external data sources 120 are represented in FIG. 1 as isolated databases or data sources, it is appreciated that these data sources, which can utilize, among others, any of the previously described data storage systems, can be distributed across multiple electronic devices, data storage systems, or other electronic systems. Moreover, although the data sources of proprietary data sources 110 are shown as distinct systems or components accessible through API 130, it is appreciated that in some embodiments these various data sources can access one another directly through interfaces other than API 130.

In addition to providing access directly to data storage systems such as database 111 or data source 113, proprietary data sources 110 can include data system 116. Data system 116 can connect to one or multiple data sources, such as database 115. Data system 116 can provide an interface to the data stored in database 115. In some embodiments, data system can combine the data in database 115 with other data or data system 116 can preprocess the data in database 115 before providing that data to API 130 or some other requestor.

Proprietary data sources 110 can further include predictive analysis engine 118. Predictive analysis engine 118 can use data stored in database 117 and can store new data in database 117. Predictive analysis engine can both provide data to other systems through API 130 and receive data from other systems or components through API 130. For example, predictive analysis engine 118 can receive, among other things, information on purchases made by users, updates to travel preferences, browsed services, and declined services. The information gathered by predictive analysis engine 118 can include anything data related to both information stored in the other components of proprietary data sources 110 as well as information from external data sources 120.

Using this data, predictive analysis engine 118 can utilize various predictive analysis and machine learning technologies including, among others, supervised learning, unsupervised learning, semi-supervised learning, reinforcement learning, and deep learning. These techniques can be used to build and update models based on the data gathered by predictive analysis engine 118. By applying these techniques and models to new data sets, predictive analysis engine 118 can provide information based on past behavior or chooses made by a particular individual. For example, predictive analysis engine can receive data from augmented reality device 145 and augmented reality system 140 regarding a particular individual. Predictive analysis engine 118 can use profile information and past purchase information associated with that individual to determine travel services, such as seat upgrades or in-flight amenities, that the individual might enjoy. For example, predictive analysis engine 118 can determine that the individual has never chosen to upgrade to first class but often purchases amenities such as premium drinks and in-flight entertainment packages. Accordingly, predictive analysis engine can determine that the individual can be presented with an option to purchase these amenities and not an option to upgrade their seat. It will now be appreciated that predictive analysis engine 118 is capable of using advanced techniques that go beyond this provided example. Proprietary data sources 110 can represent various data sources (e.g., database 111, data source 113, database 115, data system 116, database 117, and predictive analysis engine 118) that are not directly accessible or available to the public. These data sources can be provided to subscribers based on the payment of a fee or a subscription. Access to these data sources can be provided directly by the owner of the proprietary data sources or through an interface such as API 130, described in more detail below.

Although only one grouping of proprietary data sources 110 is shown in FIG. 1, a variety of proprietary data sources can be available to system 100 from a variety of providers. In some embodiments, each of the groupings of data sources will include data related to a common industry or domain. In other embodiments, the grouping of proprietary data sources can depend on the provider of the various data sources.

For example, the data sources in proprietary data sources 110 can contain data related to the airline travel industry. In this example, database 111 can contain travel profile information. In addition to basic demographic information, the travel profile data can include upcoming travel information, past travel history, traveler preferences, loyalty information, and other information related to a traveler profile. Further in this example, data source 113 can contain information related to partnerships or ancillary services such as hotels, rental cars, events, insurance, and parking. Additionally, database 115 can contain detailed information about airports, airplanes, specific seat arrangements, gate information, and other logistical information. As previously described, this information can be processed through data system 116. Accordingly, in this exemplary embodiment, the data sources in proprietary data sources 110 can provide comprehensive travel data.

Similar to proprietary data sources 110, external data sources 120 can represent various data sources (e.g., maps data 121, mood data 123, airport rules data 127, flight data 129, and location data 125). Unlike proprietary data sources 110, external data sources 120 can be accessible to the public or can be data sources that are outside of the direct control of the provider of API 130 or system 100.

Although only one grouping of external data sources 120 is shown in FIG. 1, a variety of external data sources can be available to system 100 from a variety of providers. In some embodiments, each of the groupings of data sources will include data related to a common industry or domain. In other embodiments, the grouping of external data sources can depend on the provider of the various data sources. In some embodiments, the external data sources 120 can represent every external data source available to API 130.

Moreover, the specific types of data shown in external data sources 120 are merely exemplary. Additional types of data can be included and the inclusion of specific types of data in external data sources 120 is not intended to be limiting.

As shown in FIG. 1, external data sources 120 can include maps data 121. Maps data can include location, maps, and navigation information available through a provided API such as, among others, Google Maps API or the Open Street Map API. Mood data 123 can include different possible moods of a customer and possible interactions to counter the bad mood or continue to keep the customer in a happier mood, etc. For example, mood data 123 can include data from, among others, historical feedback provided by customers and customer facial analysis data. Location data 125 can include specific data such as business profiles, operating hours, menus, or similar. Airport rules data 127 can be location specific rules, for example baggage allowances in terms of weight and count. Flight data 129 can include flight information, gate information, or airport information that can be accessed through among others, the FlightStats API, FlightWise API, FlightStats API and the FlightAware API. Each of these external data sources 120 (e.g., maps data 121, mood data 123, weather data 127, flight data 129, and location data 125) can provide additional data accessed through API 130. In some embodiments, the flight data may be part of proprietary data sources 110.

As previously described, API 130 can provide a unified interface for accessing any of the data available through proprietary data sources 110 and external data sources 120 in a common interface. API 130 can be software executing on, for example, a computing device such as computing device 200 described in relation to FIG. 2. In these embodiments, API 130 can be written using any standard programming language (e.g., Python, Ruby, Java, C, C++, node.js, PHP, Perl, or similar) and can provide access using a variety of data transfer formats or protocols including, among others, SOAP, JSON objects, REST based services, XML, or similar. API 130 can provide receive request for data in a standard format and respond in a predictable format.

API 130 can combine data from one or more data sources (e.g., data stored in proprietary data sources 110, external data sources 120, or both) into a unified response. Additionally, in some embodiments API 130 can process information from the various data sources to provide additional fields or attributes not available in the raw data. This processing can be based on one or multiple data sources and can utilize one or multiple records from each data source. For example, API 130 could provide aggregated or statistical information such as averages, sums, numerical ranges, or other calculable information. Moreover, API 130 can normalize data corning from multiple data sources into a common format. The previous description of the capabilities of API 130 is only exemplary. There are many additional ways in which API 130 can retrieve and package the data provided through proprietary data sources 110 and external data sources 120.

Augmented reality system 140 can interact with augmented reality device 145 and API 130. Augmented reality system 140 can receive information related to augmented reality device 145 (e.g., through wireless communication system 306 of FIG. 3). This information can include any of the information previously described in relation to FIG. 3. For example, augmented reality system 140 can receive location information, motion information, visual information, sound information, orientation information, biometric information, or any other type of information provided by augmented reality device 145. Additionally, augmented reality system 140 can receive identifying information from augmented reality device 145 such as a device specific identifier or authentication credentials associated with the user of augmented reality device 145.

Augmented reality system 140 can process the information received and formulate requests to API 130. These requests can utilize identifying information from augmented reality device 145, such as a device identifier or authentication credentials from the user of augmented reality device 145.

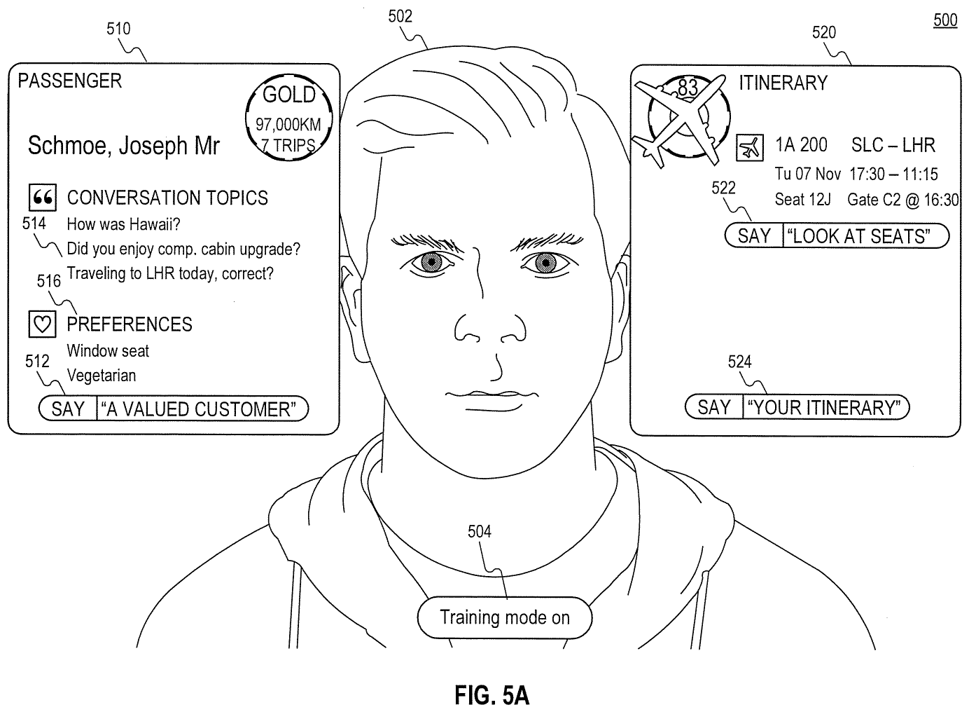

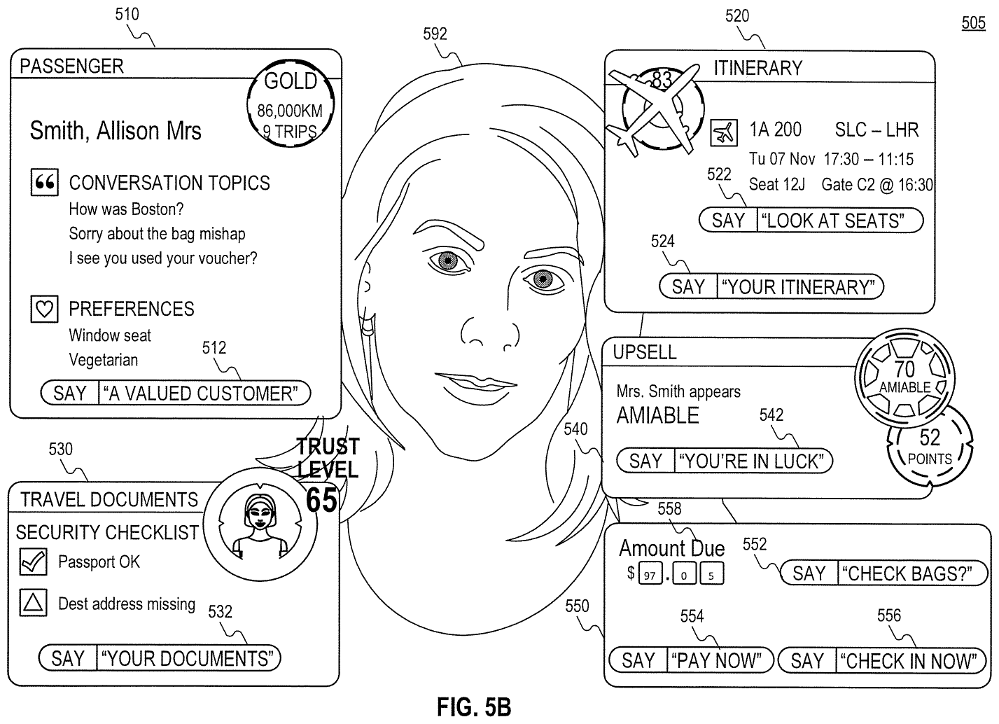

In addition to receiving information from augmented reality device 145, augmented reality system 140 can push updated information to augmented reality device 145. For example, augmented reality system 140 can push updated flight information to augmented reality device 145 as it is available. In this way, augmented reality system 140 can both pull and push information from and to augmented reality device 145. Moreover, augmented reality system 140 can pull (e.g., via API 130) information from external data sources 120. For example, if a passenger at the airport requests to be checked-in, augmented reality system 140 can acquire travel reservation information and guide the agent to help check-in the passenger by providing the itinerary information on augmented reality device 145 via a customized user interface (e.g., as provided in an itinerary information window 520 of FIG. 5A).

Using the information from augmented reality device 145, augmented reality system 140 can request detailed information through API 130. The information returned from API 130 can be combined with the information received from augmented reality device 145 and processed by augmented reality system 140. Augmented reality system 140 can then make intelligent decisions about updated augmented reality information that should be displayed by augmented reality device 145. Exemplary use cases of this processing are described in more detail below in relation to FIGS. 5A, 5B, 6A-6C, 7 and 8. Augmented reality device 145 can receive the updated augmented reality information and display the appropriate updates on, for example, viewport 391 shown in FIG. 3B, using display devices 393.

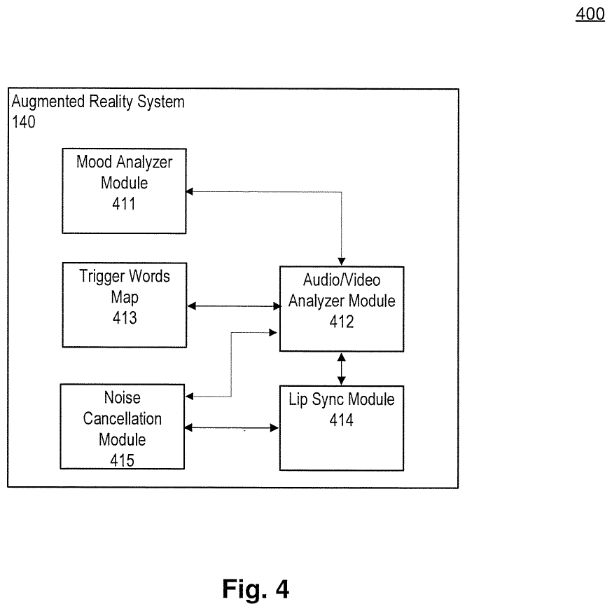

FIG. 4 is a block diagram of an exemplary configuration augmented reality system 140, consistent with embodiments of the presented disclosure. In some embodiments, FIG. 4 can represent an exemplary set of software modules running on computing device 200 communicating internally. In some other embodiments, each module is implemented on a separate computing device 200. In some embodiments the modules are accessed via API 130 similar to data sources 110 and 120.

Augmented reality system 140 can be a group of software modules, such as mood analyzer module 411, audio/video analyzer module 412, trigger words map 413, noise cancellation module 414, and lip sync module 415 implemented on computing device 200. Mood analyzer module 411 helps determine the mood of a person in the field of view of an augmented reality device. Mood analyzer module 411 determines the mood based on both audio and video information of the person. In some embodiments, mood analyzer module 411 takes into consideration historical information of the person whose mood is being analyzed. Mood analyzer module 411 accesses such historic information using API 130 to connect to various data sources (e.g., proprietary data sources 110 and external data sources 120 in FIG. 1). For example, a traveler who has travelled regularly in business class would be more interested in information about the upgrades, and mood analyzer module 411 can use this information to determine the mood to be amiable for such an interaction.

In some embodiments, mood analyzer module 411 may further combine the possible interactions possible based on the historic information to different moods. For example, a traveler who has just completed a long leg may not appreciate a solicitation to surrender their seat on a subsequent connection in exchange for a travel voucher, thereby setting the mood for this interaction to be non-amiable. Alternatively, the same traveler might be interested in hearing about a lounge access to stretch and freshen up and so mood analyzer module 411 determines the mood to be amiable for this interaction.

Audio/video analyzer module 412 analyzes video and audio content received by the system (e.g., integrated augmented reality system 100 of FIG. 1) from an augmented reality device (e.g., augmented reality device 390 of FIG. 3B or augmented reality device 145 of FIG. 1) through a network interface (e.g., network interface 218 of FIG. 2).

Audio/video analyzer module 412 aids in communicating with audio and video as input commands and data to the system 100. Audio/video analyzer module 412 may allow audio communication with a speech-to-text engine to convert the audio to text-based commands and information. Audio/video analyzer module 412 may allow video-based communication by determining when the person with whom the agent is interacting with is actually talking and only then extract data. For example, multiple travelers attempting to check-in provide travel details including destination addresses. The audio/video analyzer module 412 can analyze the video to determine when the audio received by the augmented reality device is from the intended traveler versus other nearby travelers such as by analyzing the lip movement.

In some embodiments, video analyzer module 412 may utilize the captured video to determine the mood of the person. The captured video may be chunked by frame and a single frame/image may be used to determine the facial expressions and predict mood of the person. Augmented reality system 140 may pass the facial expression data to predictive analysis engine 118 to determine the mood of the person. In some embodiments, the facial expressions may be directly compared to mood data 123 to determine the mood of the person. In some other embodiments, audio captured by microphone 322 is used to determine the mood of the person. Text obtained from parsed audio may help determine the mood of the person. Like video analysis, audio captured by augmented reality system 140 may be transmitted to predictive analysis engine 118 along with mood data 123 to determine the mood of the person.

A trigger words map 413 is a table of words mapped to trigger words, which are a sequence of one or more words that uniquely map to a sequence of actions to be taken and information to be shown. In some embodiments, trigger words map 413 may be stored as part of proprietary data source and stored in databases 115 or 117. Audio captured using microphone 322 and received using input devices 307 may be transferred to the audio/video analyzer module to parse the audio prior to requesting trigger words map 413 to help determine possible actions to execute and information to retrieve.

A lip sync module 414 can be used to determine whether the captured audio was from an individual who the user of the augmented reality device is interacting with. Augmented reality system 140 analyzes the captured audio and the lip movement of an individual to determine the point in time the captured audio is to be stored versus discarded. For example, lip sync module 414 can help determine whether received audio corresponds to the targeted individual or from other people, and can be useful in crowded or noisy environments (e.g., such as an airport). In some embodiments, lip sync module 414 can be part of audio/video analyzer module 412.

Moreover, noise cancellation can be used when augmented reality devices are used in public spaces to interact with customers and help serve them. One complexity is determining when someone is interacting with the user of the augmented reality device. A noise cancellation module 415 may work in combination with lip sync module 414 or audio/video analyzer module 412 to determine whether certain audio needs to be marked noise. In some embodiments noise cancellation module 415 may consider every portion of audio with no lip movement recognized by lip sync module 414 to be noise. In some embodiments, noise cancellation module 415 may discard portions of audio only when there overlap between lip movement as recognized by lip sync module but does not sync with the captured audio.

FIGS. 5A and 5B are diagrams of exemplary customized user interfaces of augmented reality devices when interacting with an individual, consistent with embodiments of the present disclosure. FIG. 5A is an exemplary customized user interface 500 displayed on an augmented reality device (e.g., augmented reality device 390 from FIG. 3B or augmented reality device 145 from FIG. 1) displaying information on the augmented reality device with a training mode on while interacting with intended person 502. FIG. 5B is an exemplary customized user interface 505 displayed on an augmented reality device (e.g., augmented reality device 390 or augmented reality device 145) with the training mode turned off while interacting with intended person 592. Throughout descriptions of FIGS. 5A and 5B reference will be made to elements previously discussed in FIGS. 1-4 by their appropriate reference numbers.

In FIG. 5A, customized user interface 500 shows information about an intended person 502 in a field of view of the augmented reality device. Customized user interface 500 can be viewed through viewport 391 from FIG. 3B and can be the result of display devices 393 from FIG. 3B projecting graphical overlays provided by left eye display 311 and right eye display 313 of display subsystem 310 of FIG. 3A.

Referring back to FIG. 5A, customized user interface 500 may be intended to aid user of the augmented reality device to interact with an intended person 502. Intended person 502 is the individual in the field of view of augmented reality device. Customized user interface 500 includes information related to intended person 502. Customized user interface 500 is overlaid on the display device 393 displaying information about intended person 502.

Customized user interface 500 can represent graphical overlays on viewport 391 resulting in customized user interface 500 for interacting with intended person 502. For example, the graphical elements of customized user interface 500 can include windows displaying information about intended person 502 in the field of view. Elements within an information window of customized user interface 500 may be grouped by topic such as passenger information and itinerary information shown using PASSENGER information window 510 and ITINERARY information window 520. Customized user interface 500 graphical elements further include possible actions elements on an information group displayed in an information window. Action elements are displayed as a trigger word sequence, which when uttered cause an action related to the information group to be taken. PASSENGER information window 510 includes a single action element with the trigger word sequence “A VALUED CUSTOMER” 512. An action element may be a method or a software program. In some embodiments, an action element may be an API call and some or all parameters to the API call are determined based on the trigger word sequence. A trigger word sequence thus acts as an abstraction of the action element. A single information window may be associated with multiple action elements. For example, ITINERARY information window 520 is associated with two action elements with trigger word sequences “LOOK AT SEATS” 522 and “YOUR ITINERARY” 524. Customized user interface 500 graphical elements may further include visual indicators showing ancillary information. Customized user interface 500 includes a “Training mode on” 504 visual indicator providing ancillary information that the augmented reality device may be running in training mode and may have limited functionality. In some embodiments, the visual indicator 504 may further indicate that the augmented reality device 390 may assist the user through the process by providing audible instructions, gradually revealing additional information (i.e., progressive disclosure), etc.

Information window graphical elements in customized user interface 500 may be presented as several non-overlapping windows surrounding intended person 502. For example, customized user interface 500 includes PASSENGER and ITINERARY information windows 510 and 520 displayed in a non-overlapping fashion on left and right-hand side of intended person 502, respectively. In other embodiments, windows may be stacked and revealed in a sequential order. In some embodiments, some of the customized user interface information windows may be disabled or hidden until action elements associated with currently displayed information windows are considered complete. The information windows may be considered complete by interacting with the action elements by utterance of trigger word sequences. In some embodiments, customized user interface 500 may be displaying windows related to multiple intended people at the same time. For example, a traveler wanting to check-in their whole family at an airport can result in information windows displaying all passengers' information in one or multiple windows.

Information windows display information that may be fetched from both proprietary data sources 110 and external data sources 120 by augmented reality system 140 and transferred to augmented reality device 390 to be presented as customized user interface 500. For example, the augmented reality system can query proprietary data sources as well as external data sources to retrieve the itinerary of intended person 502. The information can be directly displayed as for example, flight and seat number and departure time and gate number. Additionally, augmented reality system 140 could combine the intended person information with possible interactions to reveal additional individual information.

The underlying information under each information window may be linked to action elements represented by trigger word sequences. Reciting the trigger word sequence may reveal additional information and action elements. For example, the user of the augmented reality device upon saying the trigger word sequence ‘LOOK AT SEATS’ 522 may result in a new window showing a seat map, available seats, and the currently assigned seat. The trigger words of a trigger word sequence can be part of longer sentence preserving the order of the words in the trigger word sequence. For example, the sentence “Let's take a LOOK AT your SEATS,” will match the trigger word sequence “LOOK AT SEATS” 520 as it has all the words of the trigger word sequence present in the sentence in order within a particular time frame. In some embodiments, there may be multiple trigger word sequences with similar meaning associated with a single action element. Multiple trigger word sequences with similar meaning might be predetermined or may be determined from the interaction between the user of the augmented reality device 390 and intended person 502. The similarity may be determined by comparing the meaning of trigger word sequences associated with the action element during setup with the new word sequence. For example, the intended person may utter the words “Are there any aisle seats still available?” and the user of the augmented reality device may respond by saying “Let's take a look” resulting in the system identifying an action element associated with trigger word sequence “LOOK AT SEATS” 520.

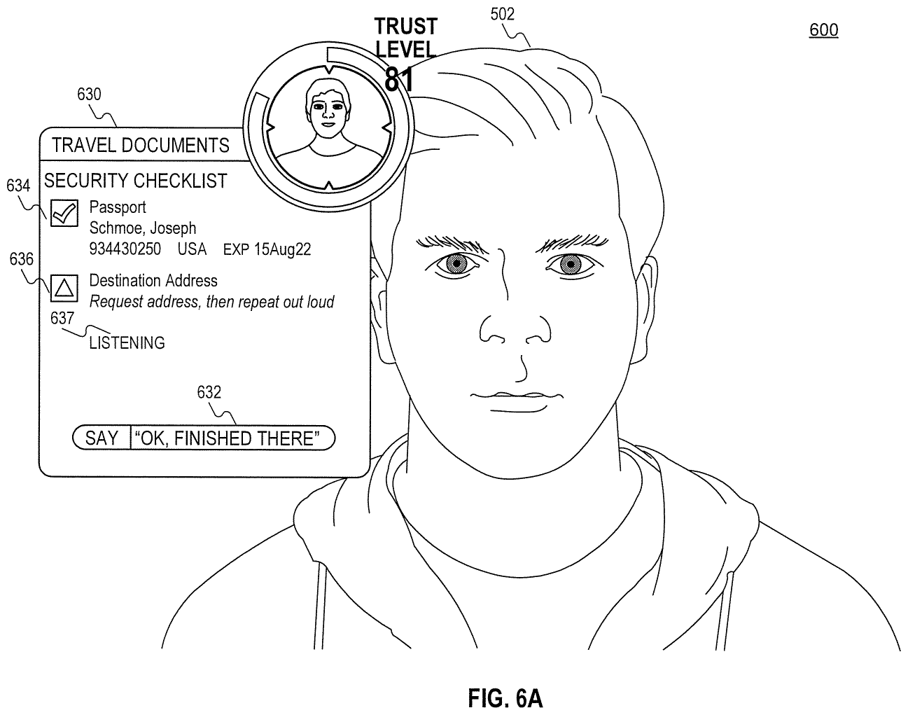

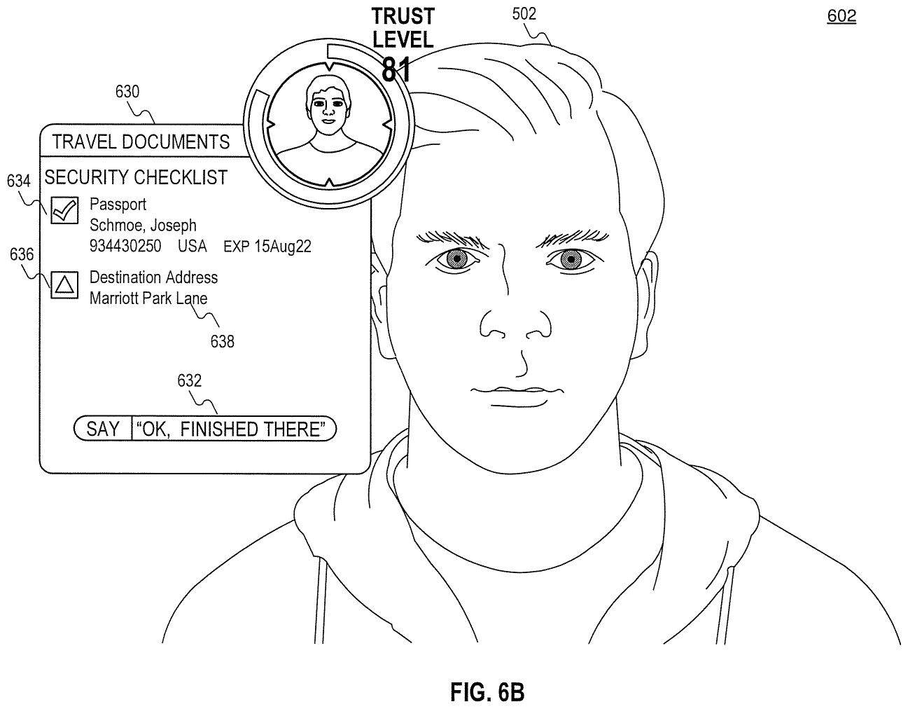

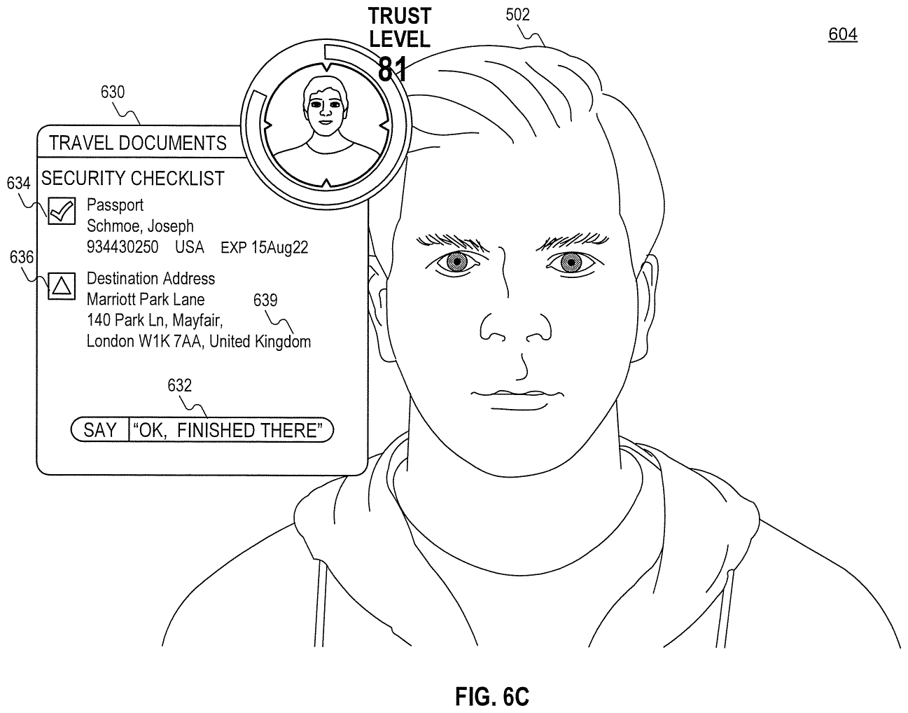

The revised user interface presented as part of customized user interface 500 may be an additional window shown. In other embodiments, the new window may replace inline an existing window. The new window may be the only window displayed. In some embodiments, saying the trigger word sequence may bring the window into focus and display more options previously hidden. Actions elements may be hidden due to space constraints or not displayed as they are lesser important or infrequently performed actions. It will be shown in FIGS. 6A-6C how one such window is brought into focus to reveal further information and additional action elements.

In some embodiments, the user interface's only interaction is to dismiss or hide the information window. The information shown in the information window is meant to prompt the user of the augmented reality device to initiate appropriate conversation topics. For example, the customized user interface 500 includes PASSENGER information window 510 displaying information in the form of hints to user of the augmented reality device. The user may choose to utilize one or more hints prior to reciting the trigger word sequence “A VALUED CUSTOMER” 512 representing the only action element linked to the window, which expands the PASSENGER information window 510, revealing additional information about the valued customer.

In some embodiments multiple action elements may be associated with a single information window. For example, in FIG. 5A, customized user interface 500 includes an itinerary information window 520 associated with action elements represented by trigger word sequences “LOOK AT SEATS” 522 and “YOUR ITINERARY” 524. A number of actions and the order of actions shown may be customized based on the user or intended person. In some embodiments, the number of actions and the order may be based on other factors such as time allotted for an interaction. For example, when a user of an augmented reality device 390 is a check-in agent and interacts with an intended person (e.g., traveler), the time allotted is based on the departure time of the intended person's flight. And when the departure time is soon approaching, the user might not be presented all upsell options available or may not be presented any at all.

Visual indicators presenting ancillary information may always be present. In some embodiments, visual indicators may be requested manually. In other embodiments, they may be automatically displayed based on context. Visual indicators may be additional information (e.g., hints 514 and 516 shown along with information windows) or state of device (e.g., training mode status 504). Visual indicators may be shown or hidden based on an experience level of the user of the augmented reality device. For example, new updates to the user interface may result in training mode automatically turning on. Further, in some embodiments, training mode might turn off after interacting with the augmented reality device a required minimum number of times. In some embodiments, training mode may turn off after interacting with the user for a defined time period or usages. In some embodiments, the experience level may be tied to the work experience. In some embodiments, the experience level may be tied to a particular role and any change in role may provide access to more features. In turn, those new features may be available only in training mode until a certain experience level is met.

FIG. 5B is an exemplary customized user interface with training mode turned off, consistent with embodiments of the present disclosure. A customized user interface 505 may allow the user of the augmented reality device (e.g., augmented reality device 145 of FIG. 1 or augmented reality device 390 of FIG. 3B) to view several possible interactions with the user not visible when training mode is turned on. Unlike the customized user interface 500 of FIG. 5A with only two information windows, the customized user interface 505 presents multiple information windows with multiple action elements to interact with. A customized user interface in training mode might restrict interaction with information windows in a sequential order in turn restricting access to the underlying information. A customized interface with training mode turned off may access all the information through multiple information windows at the same time and offer the ability for the user of the augmented reality device 145 to interact in a random order.

The additional information windows shown in customized user interface 505 may include optional information, which would not be displayed at the onset of interaction with the intended person. For example, the UPSELL information window 542 provides the ability to upsell the intended person 592 with additional services offered by the facility that employs the user of the augmented reality device 145. Such information is optional and does not stop the intended person from being served for the purpose the user of augmented reality devices interacted with the intended person.

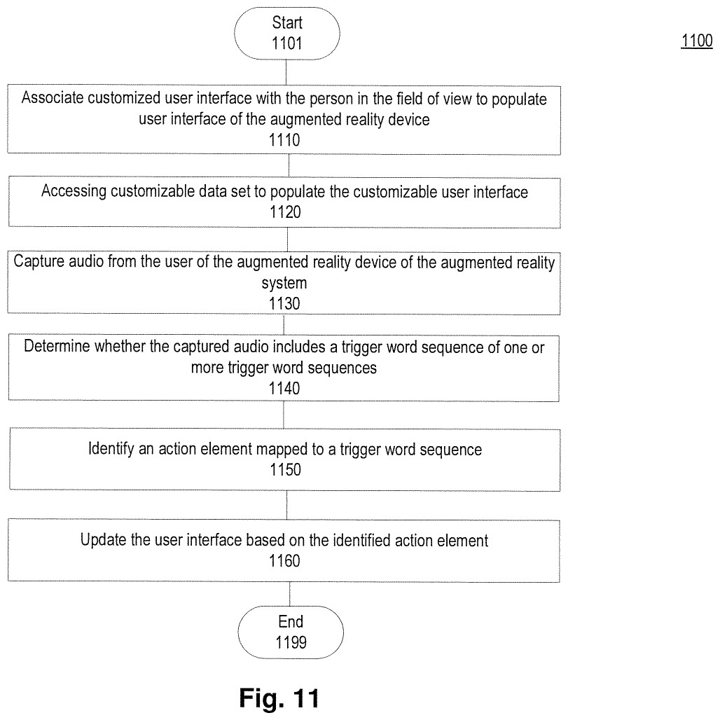

In some embodiments additional information windows can be shown when training mode is turned off by deeper evaluation of the information related to the intended person in the field of view of the augmented reality device at the onset of the interaction. For example, the UPSELL information window 540 and TRAVEL DOCUMENTS information window 530 of customized user interface 505 evaluate the historic and real-time information about the intended person to determine the amicability and trust levels and accordingly prepare and display the information windows 530 and 540 with the relevant information and action elements. FIGS. 6A-6B and FIG. 11 discuss in further detail evaluation of historic and real-time information associated with the intended person with whom of user of the augmented reality device interacts with.

The user of the augmented realty device viewing customized user interface 505 may interact with information windows by reciting the trigger word sequences representing action elements in a sequential order. Example sequential orders include clockwise or anti-clockwise manner. Alternatively, the user may decide to directly jump to final possible interaction with the intended person. For example, the user of the augmented reality device 145 display customized user interface 505 may interact with information windows in a clock wise manner beginning with ITINERARY information window or can recite “CHECK IN NOW” trigger word sequence to directly check the intended person. In some embodiments, the user of augmented reality device in FIG. 5B may be forced to interact with certain information windows prior to interacting any order. For example, the user reciting trigger word sequence “CHECK IN NOW” will be forced to interact with TRAVEL DOCUMENTS information window 530 to submit the missing information prior to check-in of the intended person 592.

In some embodiments, customized user interface 505 may be associated with multiple actions elements that can be activated when trigger words sequences are used in any order. For example, an information window 550 is associated with three action elements with trigger word sequences “CHECK BAGS” 552, “PAY NOW” 554 and “CHECK IN NOW” 556. In some embodiments, some actions may be disabled on interacting with other actions. For example, by selecting action element associated with trigger word sequence “CHECK IN NOW” 556, there may be no more opportunity to check bags. An alternative selection may result in other options being shown as the selected option. In another example, the amount due may be zero (as indicated by visual indicator “AMOUNT DUE” 558), in which case the trigger word sequence “PAY NOW” 554 and associated action element would be disabled.

In an exemplary interaction a user viewing customized user interface may begin by using information hints displayed in PASSENGER information window 510 of customized user interface 505. The user may continue interacting further to collect missing address information by interacting with TRAVEL DOCUMENTS information window 530. It will be shown in FIGS. 6A-6C how one can collect information using augmented reality system 140.

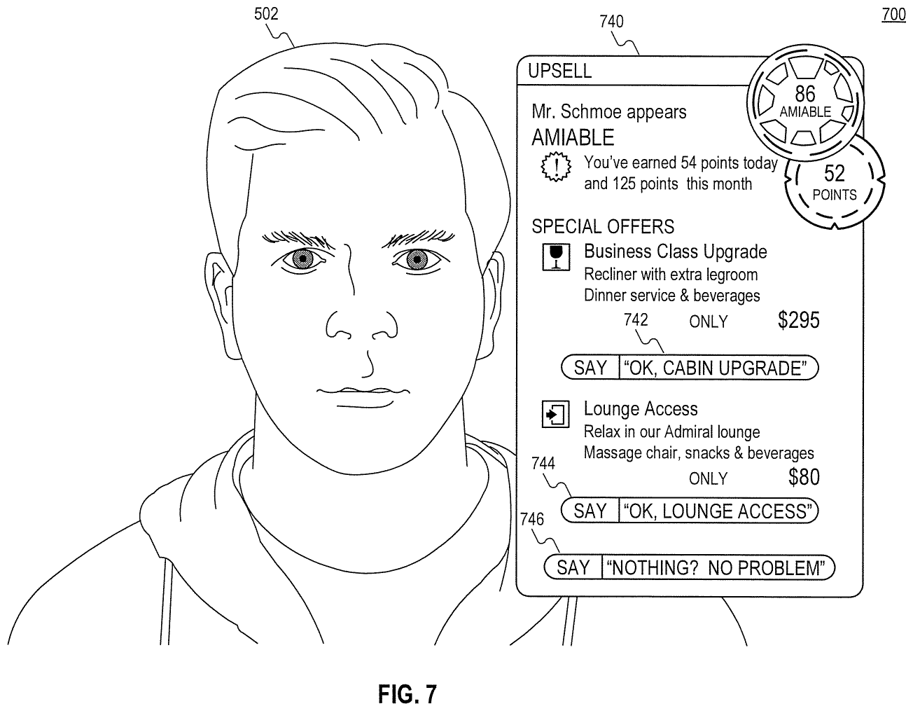

Referring back to FIG. 5B, the user of the augmented reality device 145 may have a follow-up interaction with the intended person to review the itinerary information, both seat and flight details, by reciting trigger word sequences “LOOK AT SEATS” 522 and “YOUR ITINERARY” 524 respectively of ITINERARY information window 520. The user may choose to suggest upgrade options to the intended person 592 by reciting trigger word sequence “YOU'RE IN LUCK” 542 of UPSELL 542 of UPSELL information window 540 or an alternative word sequence that indicates that user would like to see expanded UPSELL information window 540, prior to reviewing seat and flight information and thus avoid repeating selection of seats and flights. The order of interacting with information windows 520, 530 and 540 can be swapped and performed in any order according to the user's prerogative. As shown later on in FIG. 7, an expanded view of possible upgrades to upsell to a user is displayed in information window 740 of customized user interface 700 by augmented reality system 140.

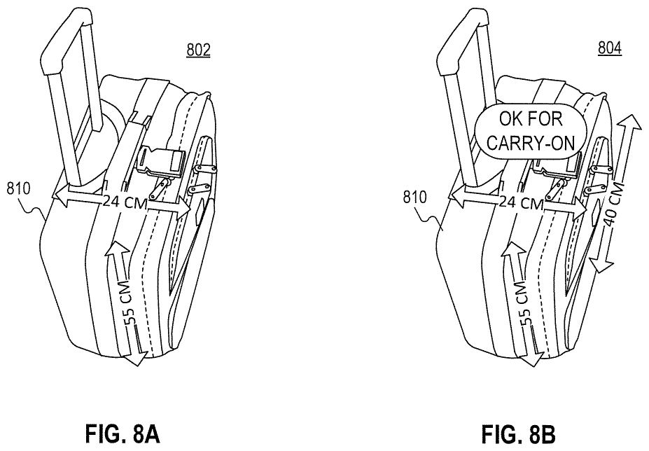

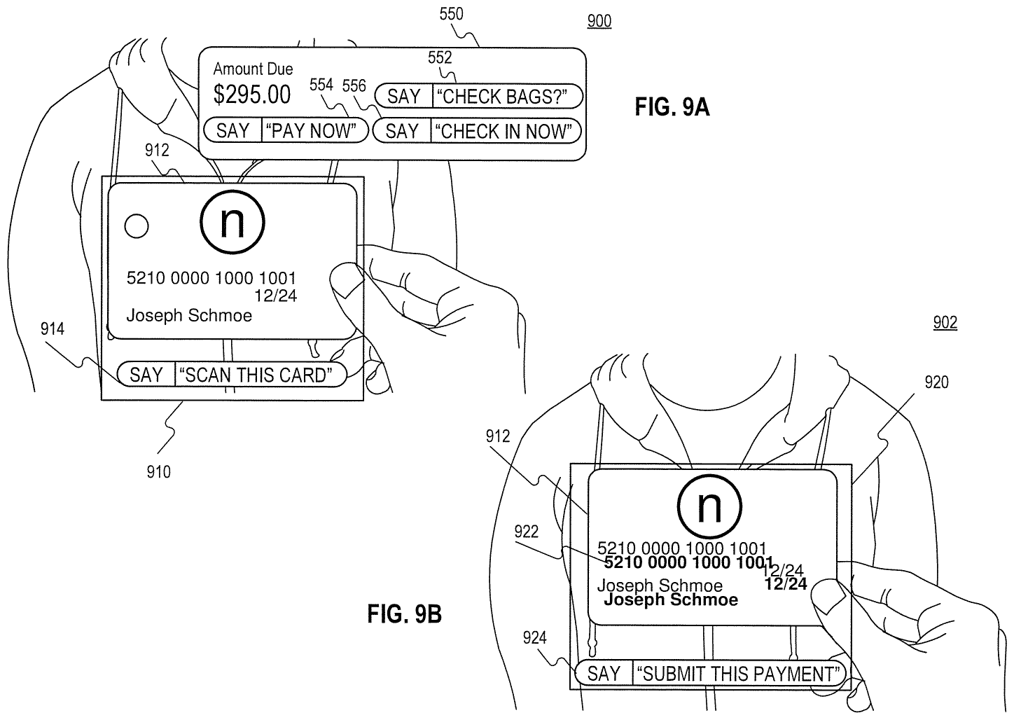

Referring back to FIG. 5B, the user may finally interact with information window 550 to pay any amount due for change of seats, flights, checked bags, or other services by uttering “PAY NOW” trigger word sequence 554 and generate boarding pass by reciting trigger word sequence “CHECK IN NOW” 556. It will be shown later on in FIGS. 8A-8B and 9A-9B how the user can interact with inanimate objects to complete the payment and check-in processes.

FIGS. 6A-6C are diagrams of exemplary interaction with intended persons in field-of-view of an augmented reality device (e.g., augmented reality device 145 of FIG. 1 or augmented reality device 390 of FIG. 3B) to update user interface, consistent with embodiments of the present disclosure. FIG. 6A is an exemplary user interface 600 waiting for input by listening for instructions. FIG. 6B is an exemplary user interface 602 parsing captured audio input to input text. FIG. 6C is an exemplary user interface 604 in which input text is used to search for additional information to populate a field. Throughout descriptions of FIGS. 6A-6C reference will be made to elements previously discussed in FIGS. 1-4 by their appropriate reference numbers.

In training mode, the augmented reality system may display information windows in a sequential order as the user of the augmented reality device interacts with the intended person 502 using the prompts provided by information windows displayed on the viewport 391 of augmented reality device. For example, in training mode the customized user interface 600 is prepared and displayed to the user of the augmented reality device on reciting trigger word sequence “YOUR ITINERARY” 524. A user (when not in training mode) can directly see the option to open the TRAVEL DOCUMENTS information window 630 of customized user interface 600. As show in FIG. 5B a user can recite the trigger word sequence “YOUR DOCUMENTS” 532 to open the information window 630 provided in FIG. 6A. While TRAVEL DOCUMENTS information window 530 displays read only information, the TRAVEL DOCUMENTS information window 630 lets the user of the augmented reality device interact with the information and allow updates.

In some embodiments, in training mode, a deeper evaluation of the intended person may be performed as the user of the augmented reality device proceeds to interact with the information windows displayed in sequential order. As mentioned in FIG. 5B such a deeper evaluation may be performed at the onset of interaction when the user of the augmented reality device has turned off the training mode. In some embodiments even when not in training mode, the augmented reality system 140 may still require further evaluation of the intended person in the field of view of the augmented reality device 145 to prepare the next set of information windows for interaction. One of the deeper evaluations may be the trust level determined by past encounters with the intended person or a real-time evaluation of person's facial expressions or spoken words analyzed by the audio/video analyzer module 412. The evaluation may require querying proprietary data sources 110 and external data sources 120.

The amount of information that can be automatically retrieved from data sources to populate the information window may depend on the trust levels of the intended person. In some embodiments, the system may expect to confirm what has been retrieved by the augmented reality system 140 and in other embodiments it may be completely missing. For example, in FIG. 6A, the intended person 502 has a trust level of 81 as shown at the top right corner of the information window 530, resulting in pre-approving passport information element 634 but leaving empty destination address information element 636 waiting to be entered. The information element of the information window may not preview the information and only indicate whether it is complete or not. For example, information element 634 may indicate availability of passport details with a check mark but not preview the actual information.

Information can be entered into the augmented reality system by typing with a keyboard or by capturing audio. For example, in customized user interface 600 the address information can be entered by speaking into the augmented reality system microphone 322, which is indicated by visual indicator 637. In some embodiments the information is entered by scanning inanimate objects. More on this will be discussed in FIGS. 9A-9B.

FIG. 6B is an intermediary step to enter information for missing information elements of a displayed information window. Information captured by listening to the intended person 502 speak may be translated to text prior to inserting it into the information element with missing information. For example, customized user interface 602 provides parsed captured audio input (received from augmented reality system 140 or augmented reality device 390) as input text. In some embodiments, the information captured in audio format may be directly saved in audio format. Information elements may allow a preview of non-textual information. For example, the captured audio from the intended person and saved to file information element 636 may be played back through speaker subsystem 320 on left and right speaker 321 and 323 instead of displayed as text.

The information element may preview temporary information, which may be used as input to search for further information. Additional information may be retrieved by submitting as search string the text retrieved by parsing captured audio. For example, destination address information element 636 of customized user interface 602 in FIG. 6B previews the temporary input search string 638. The previewed text is used as a search string to identify the actual address of the location and stored in the system.

FIG. 6C is a customized user interface 604 displaying the final input as determined by the augmented reality system 140 for missing information element 636. In some embodiments the trigger word sequences may not be active until all the required action elements part of the information window have been addressed or interacted with. For example, the trigger word sequence “OK, FINISHED THERE” 632 may be disabled until all the information elements of the information window are populated.

A user of the augmented reality device may interact with one or more interaction window elements prior to changing focus to a different information window element. For example, several elements of a travel documents information window 630 can be entered and reviewed. The user can always request the interface to save any changes to the information elements and hide TRAVEL DOCUMENTS information window 630 at any time by uttering trigger word sequence “OK FINISHED THERE” 632 or a trigger word sequence with similar meaning. The augmented reality device 145 may transmit the updated information to be stored in database 111 of proprietary data sources 110. In training mode, reciting the trigger word sequence may result in the next information window in the sequence to be displayed. When the training mode is turned off, the augmented reality system may return to previously displayed customized user interface. For example, when the training mode is turned off, reciting the trigger word sequence “OK FINISHED THERE” 632 can result in augmented reality system 140 displaying customized user interface 505.

FIG. 7 is a diagram of an exemplary customized user interface 700 to handle optional information display and interaction in an augmented reality device of FIG. 3B based on identity information, consistent with embodiments of the present disclosure. Throughout the description of FIG. 7, reference will be made to elements previously discussed in FIGS. 1-4 by their appropriate reference numbers.

In training mode, interaction with customized user interfaces of an augmented reality device may interleave information windows for required steps with information windows for optional steps when displaying information windows in customized user interface in sequential order. For example, a user of the augmented reality device reciting trigger word sequence “OK, FINISHED THERE” 632 in FIG. 6C results in the displaying of UPSELL information window 740 with optional action elements to upsell. A user not in training mode may activate the UPSELL information window 740 by reciting the trigger word sequence “YOU'RE IN LUCK” 542.

Unlike the information window 630 of FIG. 6C, which may require all action elements to be interacted with before trigger word sequence “OK FINISHED THERE” 632 is recited, the UPSELL information window 740 may allow all three action elements represented by trigger word sequences “OK, CABIN UPGRADE” 742, “OK, LOUNGE ACCESS” 744 and “NOTHING? NO PROBLEM” 746 available for interaction at the same time. In some embodiments, triggering an action element by reciting trigger word sequence may on completion of the action element result in returning to the previous interaction window. For example, a user reciting “OK CABIN UPGRADE” trigger work sequence 742 or “OK, LOUNGE ACCESS” trigger word sequence 744 may result in a new information windows shown to upgrade those services. In some scenarios, the action element may only result in an inline performance of the associated action element and not open any new information window. For example, on reciting trigger word sequence “OK CABIN UPGRADE” or “OK, LOUNGE ACCESS” may not result in a new information window being shown. These are just exemplary upsell offers trigger word sequences. In some embodiments, there may be more, or fewer offers, and they may vary based on the location of the facility or service provider at a facility. For example, an airline service at an airport facility may not have lounge service or have them only at certain airport facilities resulting in not presenting the lounge service offer. In some embodiments, the offers may be based on the preference of intended person preferences with whom the user of the augmented reality device is interacting with, or time available for an interaction. For example, if the intended person is traveling and has a flight to board in a few minutes, the system probably wouldn't offer lounge access, but may present onboard fresh towelette and bottled water offers. In some other embodiments, the augmented reality system may not offer any services. For example, the system wanting to avoid a delayed departure of a plane may prioritize check-in process over any upsell offers.

The information window 740 with optional action elements may be visible and customized based on the identity of the intended person 502. The identity information may be derived from historical information. In some embodiments, the information shown in an information window may be customized based on the historical information. Historical information could be based on a recent activity or cumulative information over a period of time. For example, historical information can be travel history and cumulative information can be a membership status determined based on the travel history. As shown in FIG. 7, customized user interface 700 includes an UPSELL information window 740 displaying information based on the identity information of the intended person 502.

In some embodiments, the identity information may be derived from real-time information. Real-time information can be verbal or visual information currently available. The real-time information visual information can be captured by the augmented reality device. Real-time visual information can include facial expressions to determine the mood of intended person 502, which may be used in customizing the user interface 700. For example, intended person 502 mood is determined as amiable resulting in upsell information window 740 include several action elements represented by trigger clauses “OK, CABIN UPGRADE” 742, “OK, LOUNGE ACCESS” 744 and “NOTHING? NO PROBLEM” 746 to process passenger ticket upgrade or airport lounge access purchase. The number of optional action elements associated with an information window may also depend on the historical and real-time information. For example, a customer who travels regularly by business class may be more interested in the cabin upgrade. Alternatively, a traveler with family members and a long layover may prefer a lounge access. Accordingly, using the information about the person can assist the user of the augmented reality device to provide a more customized experience for the person. Other options based on historical information may include onboard internet, inflight entertainment package, onboard meal or snacks, insurance etc.

User of the augmented reality device 145 interacting with intended person 502 using customized user interface 700 may select one or more optional action elements followed by reciting trigger word sequence “NOTHING? NO PROBLEM” to dismiss to current information window and access the next information window. Similar to results of reciting trigger word sequence “OK, FINISHED THERE” 632, reciting “NOTHING? NO PROBLEM” results in next information window in the sequence or going back to original customized user interface being displayed as part of the customized user interface. FIGS. 8A-8B and 9A-9B showcase two possible customized user interfaces with information window which may be displayed on dismissing the information window 740 with optional action elements.

FIGS. 8A and 8B are diagrams of exemplary user interface to utilize augmented reality device 390 of FIG. 3B as a tool to scan inanimate objects, consistent with the embodiments of the present disclosure. FIG. 8A is a diagram of an exemplary user interface of a tool to determine dimensions of an object in the field of view of the augmented realty device. FIG. 8B is a diagram of an exemplary user interface for using real-time information generated from measuring dimensions of an object to determine the eligibility to use the object. Throughout descriptions of FIGS. 8A and 8B reference will be made to elements previously discussed in FIGS. 1-4 by their appropriate reference numbers.

Certain steps involving interacting with inanimate objects, such as recognizing the type of the objects or measuring the dimensions of the object may be performed as part of an interaction with a person. For example, on completion of optional action elements of UPSELL information window 740 of customized user interface 700 of FIG. 7 or by skipping and reciting “NOTHING? NO PROBLEM” trigger word sequence 746 directly can result in the system requiring the user to measure the dimensions of the carry-on baggage. A user not using the augmented reality device in training mode may be allowed to directly interact with inanimate objects by reciting the trigger word sequence to end the interaction. For example, the user augmented reality device 390 interacting with intended person 592 (of FIG. 5B) by directly recite “CHECK IN NOW” trigger word sequence 556 to complete the process of interacting with the intended person 592 and start interaction with inanimate object 810 in FIG. 8A.

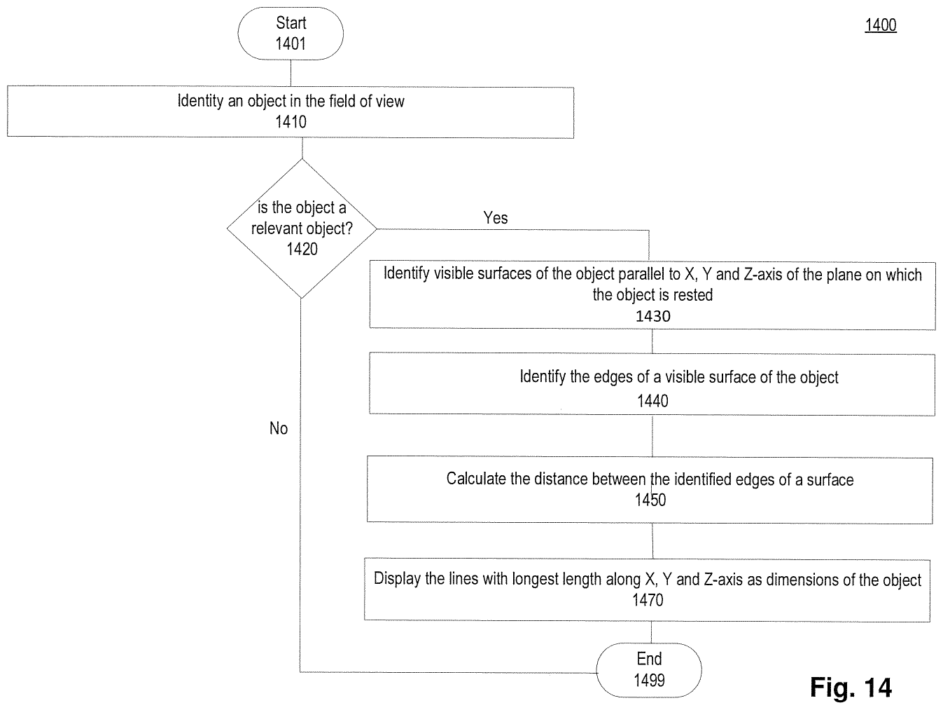

Interaction with inanimate objects may be determined based on the role of the user of the augmented reality device. For example, when a user of the augmented reality device is in the gate-agent role, the customized user interface shown in FIG. 8A can be used as a tool to determine the dimensions of the suitcase 810 in the field of view and determine if it would fit in the carry-on storage compartment on the flight. The method in FIG. 14 goes over in detail for measuring dimensions of inanimate objects in a field of view of augmented reality device.

The customized user interface shown in FIG. 8B combines the information generated by the customized user interface 802 used as a tool with prior information proprietary 110 and external 120 data sources to determine the eligibility of the object for certain use. For example, the user interface 804 may be used to determine if the suitcase 810 in the field of view can be used as a carry-on baggage. The dimensions calculated using the user interface 802 of the augmented reality device 390 are combined with airport rules data 127 and flight data 129 to determine (using the determined dimensions) whether the baggage can fit inside a carry-on storage compartment.

A system may continue to interact with objects for accessing information after interacting with inanimate objects. The user of the augmented reality device may be redirected to the original customized user interface. In some embodiments, the customized user interface may include summary of all information windows the user has interacted and providing the ability to update them. For example, user of augmented reality device interacting with intended person 592 on completion of check-in by measuring carry-on baggage dimensions and paying the due amount (as will be discussed in FIG. 9A-9B) may be shown in customized user interface 505 and provide the ability to edit and interact with any of the information displayed in information windows 510-550.

FIGS. 9A and 9B are exemplary diagrams illustrating a customization of a user interface to extract information from inanimate objects in the field of view, consistent with the embodiments of the current disclosure. FIG. 9A is an exemplary diagram of a customized user interface allowing interaction with the inanimate object in field of view upon selecting action elements. FIG. 9B is an exemplary diagram of a customized user interface identifying the type of object in field of view and displaying action elements. Throughout descriptions of FIGS. 9A and 9B reference will be made to elements previously discussed in FIGS. 1-4 by their appropriate reference numbers.

In some embodiments augmented reality device 390 may need a physical object to be placed in a position corresponding to information in an empty information window. The physical object placed in the empty information window can be initiated by reciting a trigger word sequence. For example, in FIG. 9A customized user interface allows interaction with information on a credit card 912 when placed in an information window 910 linked with an action element represented by a trigger word sequence “SCAN THIS CARD” 914. Interaction with inanimate objects to access information using an augmented reality device from surrounding environment may be performed by reciting the trigger word sequence “SCAN THIS CARD” 914 to scan the information visible on the credit card 912 using camera 324 of augmented reality system 140. Camera 324 captures images of the card and may pass it to one of the applications 334 to perform optical character recognition to identify card details. In some embodiments, no trigger word sequence needs to be spoken—the action element is triggered when an object is placed in the empty information window. Likewise, in some embodiments, an object needn't be placed in a specific position, but the augmented reality device 390 can be constantly watching for that type of object (e.g., a barcode, or text) and use it when appropriate. For example, an augmented reality device waiting on payment may identify a 16-digit sequence of numbers as a credit card number. In some embodiments, the augmented reality device 390 may scan an object in augmented reality device 390 field of view (but has no in specific empty information window position) when a trigger word sequence is recited.

The trigger word sequence to interact with inanimate objects may only be visible after placing the physical object in the empty information window. In some embodiments, the trigger word sequence does not appear until the augmented reality system recognizes the type of object. For example, if the physical object is a credit card 912, then the system 140 may display a trigger word sequence 914 to scan the card details. Alternatively, if the physical object is a plane pet kennel, the trigger word sequence may be to take a picture for future verification of true owner when returning the pets in the pet kennels.

In some embodiments, the customized user interface may include information of a physical object transferred to an information window in digital space. The augmented reality device may scan the physical object alpha numeric characters and display them in an information window. In some embodiments the information showing information transferred from a physical object to the information window may be associated with an action element. For example, in FIG. 9B, augmented reality device 390 scans inanimate credit card object 912 in the field of view and identifies the type of object to be bank issued credit/debit card and its corresponding information. The customized user interface 902 displays scanned information in an information window 920 and an associated action element represented by trigger word sequence “SUBMIT THIS PAYMENT” 924 to interact with the card details information in the information window by triggering payment for a service.

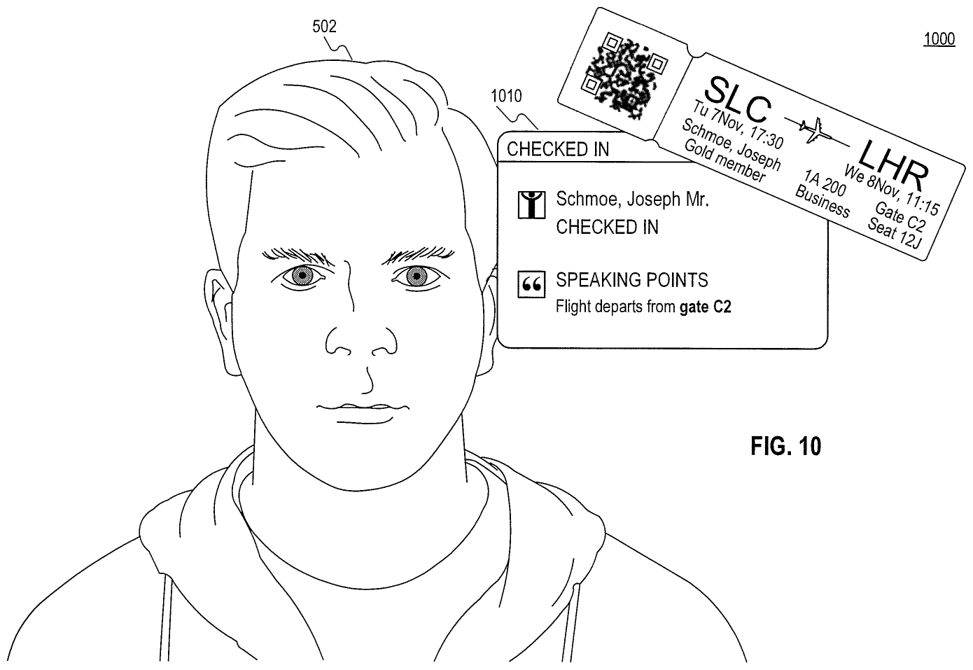

FIG. 10 is an exemplary customized user interface 1000 displaying read only information, consistent with the embodiments of the current disclosure. A user interaction with action elements linked to information windows of a customized interface on completion may result in display of final information in a read-only format. For example, the user of augmented reality device 145 completing all the steps in the sequence results in a read-only boarding pass shown in CHECKED IN information window 1010. The customized user interface 1000 may be generated on reciting “CHECK IN NOW” trigger word sequence 552. In some embodiments customized interface 1000 may be generated automatically on completion of all interactions through action element trigger word sequences. For example, the customized user interface 1000 may be displayed on augmented reality device 145 when user of the augmented realty device recites “SUBMIT THIS PAYMENT” trigger word sequence 924.

In certain embodiments, augmented reality device may display a customized user interface made up of information windows with read only information. The read only access may be due to access restrictions or based on the role of the user. For example, in FIG. 10, the customized user interface 1000 includes information window 1010 with no action elements represented by trigger word sequences. In some embodiments, the information window with no trigger words sequences is interacted by using gestures or other hardware capabilities. For example, the customized user interface 1000 is displayed when the user of the augmented reality device recites “CHECK IN NOW” is recited in FIG. 9A. A user in non-training mode can recite the same directly from customized user interface 505. The information window 1010 can be shared with the customer over email by making certain pre-defined hand gestures, which are captured by camera 324 of augmented reality device 300 of FIG. 3A and analyzed using the video analyzer module 412 of FIG. 4. The system may also use some data source to confirm that the gesture is allowed and is the appropriate gesture for the information window. In some embodiments, the email may be sent automatically. In some embodiments, both intended person and the user of the augmented reality device may have some gestures that can facilitate sharing between the two devices.

In some embodiments the identity information may include auxiliary information of the user of the augmented reality device. In some embodiments, the auxiliary information is based on the current role of the user of the augmented reality system in a facility. The facility can be a physical facility (e.g., building) or a business offering products and services. The current role of the user may depend on the employment position within a facility. For example, a gate check-in agent in an airport facility may not only have a check-in agent role but may also have access to sell tickets and services as displayed in upsell information window 740.

In some embodiments, the current role of the user of the augmented reality system may change in real-time. For example, a user in the airport facility may be assigned the role of a check-in agent when the user is in the departure check-in area of the airport facility as shown in customized user interface 700 and the same user role changes to gate agent when the user moves to the gate area as shown in FIG. 10. In some embodiments transition to different roles and requests for different customized user interfaces may be manually requested. For example, an airline agent interacting with the intended person 502 while in the middle of his/her walk to the gate may not be represented by any role as the location is not assigned a role. In such a scenario the agent may choose to manually select the role of a gate agent to help guide the intended person to their gate. The agent may choose to manually select the check-in agent role to view the customized user interface 700 to help the user purchase certain upgrades and services.

FIG. 11 is a flowchart of an exemplary method 1100 for dynamic customization of a user interface in an augmented reality system, consistent with embodiments of the present disclosure. In some embodiments, the steps of method 1100 may be performed by system 100 for purposes of illustration. It will be appreciated, however, that other implementations are possible and that other components may be utilized to implement the exemplary method. It will be readily appreciated that the illustrated method can be altered to modify the order of steps, delete steps, or further include additional steps.

At step 1110, augmented reality device (e.g., augmented reality device 390 of FIG. 3B or augmented reality device 145 FIG. 1) of an augmented reality system (e.g., augmented reality system 140) associates a customized user interface with an intended person in the field of the augmented reality device 145. The augmented reality device 145 may consider an intended person (e.g., intended person 502 of FIG. 5A) to be in the field of view if the person is visible through the viewport 391 of FIG. 3B. In some other embodiments, an intended person 502 may be considered to be in the field of view as long as the intended person's voice can be captured by microphone 322 (e.g., in situations where the user of the augmented reality device looks away from the intended person). The customizable user interface may be an empty interface, or a specific user interface created by default based on the identity of the intended person 502.

At step 1120, an augmented reality system 140 accesses customizable data set to populate the customizable user interface. The customizable information may include one or more trigger word sequences. The customizable data set may include generic trigger word sequences at the beginning of an interaction. The generic trigger word sequences may include common forms of interaction with an individual. In some embodiments, the generic trigger word sequences may include salutation or greetings one uses when interacting with another individual. For example, when a user (e.g., airline check-in agent) of the augmented reality system 140 begins interacting with an intended person (e.g., intended person 502 of FIG. 5A) the customized data set accessed by the augmented reality system may include the intended person itinerary information 520 and trigger word sequences “LOOK AT SEATS” 522 and “YOUR ITINERARY” 524. In some embodiments, the customizable user interface can be based on the intended person being recognized or identified, such as in the situations where personal information is displayed on the information windows.

At step 1130, augmented reality system captures audio from the user of the augmented reality device (e.g., augmented reality device 390 of FIG. 3B or augmented reality device 145 of FIG. 1) of augmented reality system (e.g., augmented reality system 140 of FIG. 1). In some embodiments the augmented reality system 140 accessing customized data set in the middle of a conversation may capture audio using a microphone (e.g., microphone 322 of FIG. 3A).

At step 1140, after capturing audio, the system can parse the captured audio data to identify whether a trigger word sequence (e.g., action element 524 from FIG. 5A) from the captured audio has been used. The parsing of the captured audio can be performed by an audio analyzer module (e.g., audio/video analyzer module 412 of FIG. 4). The parsed audio can uniquely identify the trigger word sequence and the appropriate action element to trigger with the help of trigger words mapping tool (e.g., trigger words map 413 of FIG. 4).

After identifying the trigger word sequence, the augmented reality system 140 can provide the identified trigger word sequence as input to determine the sources of information to display and the associated action elements. Trigger words map module 413 in the augmented reality system identifies the external and internal sources of information in system 100 to query for information. The system can prepare a customized user interface (e.g., customized user interface 500 of FIGS. 5A and 5B) and provide the prepared customized user interface to the augmented reality device (e.g., augmented reality device 390 of FIG. 3A). The customized user interface can be displayed on the viewport 391 of augmented reality device 390. For example, user of the augmented reality device 390 upon uttering trigger word sequence “VALUED CUSTOMER” 512 in FIG. 5A, the augmented reality system 140 may prepare a customized user interface 500 and displayed on viewport 391 of augmented reality device 390 of FIG. 3B and as shown in FIG. 5A.

At step 1150, augmented reality system 140 may identify an action element mapped to a trigger word sequence. An augmented reality system 140 delegates to trigger words map 413 to lookup the trigger word sequence and the mapped action to perform for the matched trigger word sequence.

At step 1160, augmented reality system 140 may update the user interface based on the identified action elements. In some embodiments, updating user interface may involve query data sourced defined in the identified action element and grouping them. Augmented reality system 140 may query one or more data sources (e.g., flight data 129 and mood data 123 of FIG. 1) defined in the action element. In some embodiments the query search fields include the details of the intended person with whom the user of the augmented reality device is interacting with. In some embodiments, the intended person details may be processed by augmented reality system software modules prior to sending them as filters of a query to a data source. For example, a query sent to mood-data source 123 may also include the audio of the intended person and video or images of the intended person processed by audio/video analyzer module 412. In some embodiments, the results of one data source are provided as input to another data source to further analyze the intended person details in determining the information to display on the customized user interface. For example, the results of a query sent to flight data 129 may be provided as input to mood-data source to determine how the mood will be based on a previous long flight and an upcoming flight and any delays in these flights.

Augmented reality system 140 may group information retrieved from one or more data sources by topic. The grouping of information may further be based on entities involved in the interaction resulting in the customized user interface being updated. For example, as shown in FIG. 5A, passenger information is grouped together and shown as PASSENGER information window 510 and information related to airlines business is grouped together as ITINERARY information window 520 of customized user interface 500. As shown in FIG. 5B, passenger information and airline business information may be divided by topic to create additional information windows TRAVEL DOCUMENTS information window 530 and UPSELL information window 540. In some embodiments, the grouped information may only include a subset of information deemed most important and reveal more information within the group on invoking the trigger word associated with the information window showing an information group. For example, TRAVEL DOCUMENTS information window 530 and UPSELL information window 540 reveal more information when the user of the augmented reality device recites trigger word sequences “YOUR DOCUMENTS” 532 and “YOU'RE IN LUCK” 542 respectively (as shown in customized user interfaces 600 of FIG. 6A and 700 of FIG. 7).

Augmented reality system 140 may create information window including grouped information and the trigger word sequence. In some embodiments, the trigger word sequence included along with the grouped information in an information window may help access further information. The further information may be present already in the system or needs to be requested from the intended person 502 with whom the user of the augmented reality system 140 is interacting with. For example, as shown in FIG. 5A, the itinerary information window 520 may display a preview of the itinerary of the intended person 502. The trigger word sequence “LOOK AT SEATS” 522 can access seat availability information already in the system and provide the ability to select a different seat. Alternatively, as shown in FIG. 6A-6C. the travel documents information window 630 may show passport details information window element 634 already in the system, but augmented reality system 140 may access the destination address information window element 636 by listening to the intended person 502.

Augmented reality system 140 may transmit the information to an augmented reality device (e.g., augmented reality device 390 of FIG. 3B or device 145 of FIG. 1). The transmitted information is received by the display subsystem 310 of the augmented reality device 390. The information may be transformed in terms of color or aspect ratio by the display subsystem 310 prior to sending it to both left eye display 311 and right eye display 313.

The system can provide (step 1160) the updated customized user interface along with other relevant information to the augmented reality device for display (e.g., as customized user interface 500 in FIG. 5A) and complete (step 1099) the process.

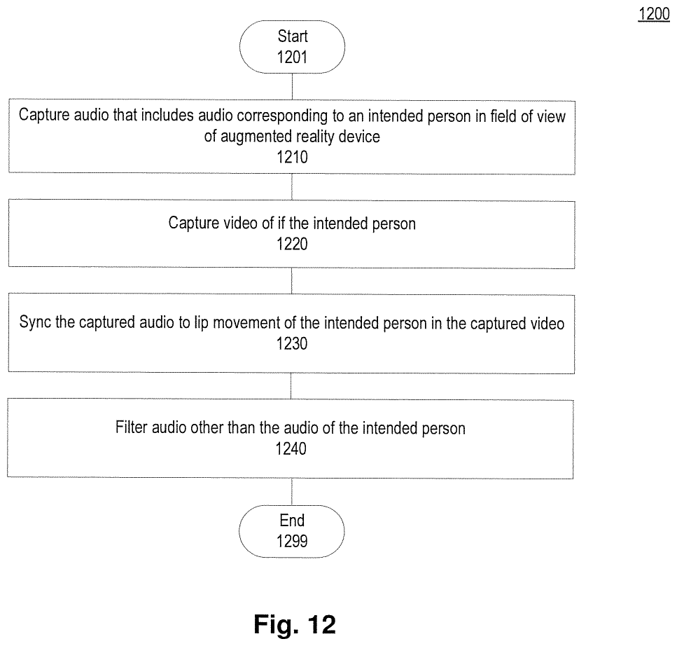

Reference is now made to FIG. 12 which depicts an exemplary method 1200 for filtering external noises during interaction with augmented reality systems, consistent with embodiments of the present disclosure. In some embodiments, the steps of method 1100 may be performed by system 100. In the following description, reference is made to certain components of system 100 for purposes of illustration. It will be appreciated, however, that other implementations are possible and that other components may be utilized to implement the exemplary method. It will be readily appreciated that the illustrated method can be altered to modify the order of steps, delete steps, or further include additional steps.

At step 1210, an augmented reality system (e.g., augmented reality system 140) captures audio that include audio of an intended person in a field of view of the augmented reality device (e.g., augmented reality device 390 or device 145). The augmented reality device captures the audio using one or more microphones (e.g., microphone 322 of FIG. 3A) and passes it to the augmented reality system. In some embodiments the audio may be captured by an external device and transmitted directly to the augmented reality device. For example, the externally captured audio may be transmitted to the augmented reality device 390 through data port 318. In some embodiments, the externally captured audio may be transmitted directly to the augmented reality system 140 implemented by computing device 200 through network interface 218.

At step 1220, augmented reality system 140 may capture video of the intended person in the field of augmented reality device. The augmented reality device 390 may capture video using camera 324. In some embodiments the captured video has embedded audio. Step 1210 may be skipped or captured audio ignored when utilizing the audio from the video stream. In some embodiments, the captured audio only includes the trigger word sequence. The captured audio is parsed to text to identify a trigger word sequence using trigger words map 413.

At step 1230, augmented reality system 140 syncs captured audio to lip movement of an intended person in the captured video. For example, augmented reality system 140 transmits the captured audio and video in steps 1210 and 1220 to lip sync module 415 to determine when the audio matches the movement of the lips of the intended person in the video. In some embodiments, the video may include multiple intended persons in the field of view resulting in various parts of the audio synced to different video sections.

At step 1240, augmented reality system 140 filters any audio that is not synced with the lip movement in the captured video of the intended person. In some embodiments, the system filters by first reviewing the complete audio and video and marking the synced sections from step 1230 and clipping those marked sections. In some embodiments, augmented reality system 140 marks captured audio for extraction when the lip movement in the captured video syncs with the captured audio. In some embodiments, augmented reality system marks a certain length of audio for extraction. In some other embodiments, the augmented reality system continues to mark audio for extraction as long as the lips of the intended person in the video sync to the captured audio. A mark is added to the audio file when the lip movement in the video stream syncs with the audio stream. Another mark is added to the audio file when the lip movement in the video stream stops syncing with the audio. The marks added to the file may be time stamps of start and end points to clip, stored in a separate file with the audio file name they are associated with listed in the same file. The augmented reality system 140 requests the lip sync module 414 to identify the synced sections between the audio and video streams captured by the augmented reality device 145. In some embodiments multiple people may be in field of view of the augmented reality device and lip sync module 414 may request audio/video analyzer module 412 to crop or extract the portions of the video based on the lip movement and group the cropped into sets by each person in field of view.

In some embodiments, augmented reality system 140 clips the captured audio marked for extraction. The markers indicate the starting and end in points in the audio stream when person in the augmented reality device field of view has spoken. The rest of the audio is discarded as external noise may include both human voices and other noises. Lip sync module 414 may request noise cancellation module 415 to discard the audio not between marked sections in step 1240. In some embodiments, the audio considered to have information is stored in the data store. In such cases, the augmented reality system may decide to not discard the non-synced audio. For example, when the audio matches the signature of the audio of previously synced audio signature within the same interaction, it can indicate that the person is part of a group of individuals interacting together with the user of the augmented reality device. The system can request audio/video analyzer module 412 to compare audio signature with the signature in the non-synced portions of the captured audio.

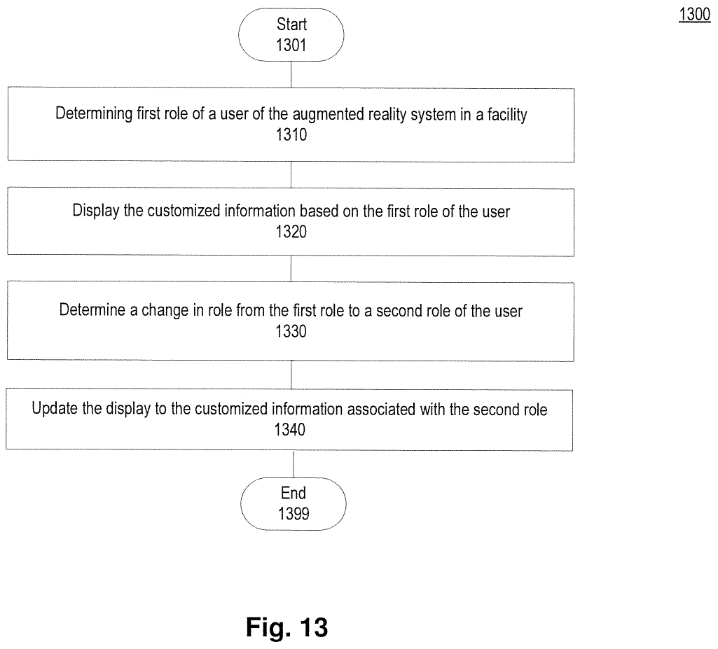

FIG. 13 is a flowchart of an exemplary method 1300 to customize the user interface of an augmented reality device (e.g., augmented reality device 390 of FIG. 3B or augmented reality device 145 of FIG. 1) using dynamic display of information. The dynamic display of information may be based on the role of the user of the augmented reality device. The customized user interface defaults to a default common user interface at the beginning or when the role of the user is not established. In some embodiments, the steps of method 1300 may be performed by system 100 for purposes of illustration. It will be appreciated, however that other implementations are possible and that other components may be utilized to implement the exemplary method. It will be readily appreciated that the illustrated method can be altered to modify the order of steps, delete steps, or further include additional steps.

At step 1310, augmented reality system 140 may determine the role of a user of an augmented reality device (e.g., augmented reality device 145 of FIG. 1). Role of a user can be either short term or longer term. For example, a user role may be based on employment position and can be assigned long term until the employee is promoted to a new position. In some embodiments role of the user may be permanent. In some embodiments a user may have multiple roles that might be a combination of permanent and temporary roles. For example, the augmented reality system 140 may use the location of a user in an airport facility to determine that the user of the augmented reality system is an airline check-in agent when the user is in the departure ticketing section of airport facility. The same user rule may temporarily change to a gate agent when the user moves to the aircraft gate location in an airport facility. In another example, a senior employee of an airline with experience may always be able and have the gate agent role but can temporarily have the role of check-in agent added when they are present in the departure ticketing section of airport facility.

At step 1320, augmented reality system 140 finds information based on the role of the user. Finding customized information includes querying data sources based on the role. In some embodiments the type of data sources that can be queried and the entries within a data source can be accessed are based on the role. In some embodiments, the queried information is filtered based on role restrictions prior to presenting to the user. For example, user role based on experience level can be determined by querying usage statistics to display all information at once or in a sequential order. The user of the system in FIG. 5A is a beginner user and has only the passenger and itinerary information available and further information is revealed in a sequential order. Alternatively, in FIG. 5B the user is an experienced user and has all the information presented at the onset of the interaction with intended person 592.

At step 1330, a change in role of the user of the augmented reality device (e.g., augmented reality device 390 of FIG. 3B or augmented reality device 140) is identified by the augmented reality system (e.g., augmented reality system 140). The change in role may be determined based on the updated location of the augmented reality device determined by GPS 309, Wireless Communications 306, or Accelerometer 342. For example, a role which is based on the location in an airport facility identified by GPS 309 of augmented reality device 390 as the user moves from a check-in area to a departure gate past security, the role of the agent can change from check-in agent to gate agent. In embodiments where the GPS signal is impermissible, location data may be determined by wirelessly communicating with transceivers. For example, when a travel agent moves in an airport facility within the same building from international terminal gate to a domestic terminal gate, the updated location can be identified by the updated router information used for connecting to the internet and can be obtained from wireless communications 306. The wireless communications 306 can be other sensors 346, such as specialized beacon technology transceivers to wirelessly connect to the device to indicate to the augmented reality system 140 the location of the user of the device 390 within a building where GPS signal cannot be utilized. In some embodiments, the augmented reality system 140 may identify the location of the user of the augmented reality device 390 by capturing images of the surroundings using camera 324 and uniquely recognizing the location by reconstructing a 3D unique image of the location.

At step 1340, display is updated based on customized information associated with a changed role. The updated customized information is displayed on the augmented reality device (e.g., augmented reality device 390 of FIG. 3B). In some embodiments, updating display of information may require clearing the past information windows. In some embodiments updating display of information may only involve refreshing the contents of an information window or adding additional information at the bottom. For example, a traveler who agrees to several upgrades can result in the amount due to be updated in amount due window (e.g., information window 550 of FIG. 5B) and selected upgrades added to the upgrade information window (e.g., UPSELL information 540 of FIG. 5B or UPSELL information window 740 of FIG. 7).

FIG. 14 is a flowchart of an exemplary method for determination of dimensions of an object using augmented reality systems, consistent with embodiments of the present disclosure. In some embodiments, the steps of method 1400 may be performed by system 100 for purposes of illustration. It will be appreciated, however that other implementations are possible and that other components may be utilized to implement the exemplary method. It will be readily appreciated that the illustrated method can be altered to modify the order of steps, delete steps, or further include additional steps.

At step 1410, augmented reality system 140 may identify an object in the field of view. The user of the augmented reality device 390 may be directed through customized user interface to access information of a certain type and the intended person with whom the user of augmented reality device is interacting with may point to the inanimate object, which may provide the information required by the user. For example, the customized user interface on capturing trigger word sequence “CHECK IN NOW” 556 can recommend the user to look for a carry-on baggage and measure its dimensions requiring the user to change his/her focus from the intended person to a carry-on baggage in the surrounding area.

At step 1420, augmented reality system 140 may determine if the object is a relevant object to measure in a facility where the augmented reality system is being used. Relevancy of the object may be determined by identifying the type of the object and looking it up in the list allowed types. The type of the object can be recognized using the audio/video analyzer module 412 and the look up can be performed by querying the proprietary data sources and searching if the identified type is listed as allowed type of object. For example, the audio/video analyzer module 412 receives an image of a suitcase during a check-in process in an airport facility and identifies it as an allowed type of object for carry-on. In another example, the audio/video analyzer module 412 receives an image of a baby stroller and determines it is a not an allowed type for carry-on and ignores for measuring its dimensions (at which point the method ends 1499). The audio/video analyzer module may use a neural network and compare the received image of the object with allowed object type images to find the closest match and in turn determine the type of the object.

If the object is a relevant object, at step 1430, augmented reality system 140 may identify visible surfaces of the object parallel to X, Y, and Z-axes relative to a plane on which the object is rested. In some embodiments, an object may have several visible surfaces and those not parallel to X, Y, and Z axes are discarded. In circumstances where no visible surface is parallel to a certain axis, a virtual rectangle is created parallel to the axis and considered the visual surface of the object In order to measure dimension along the certain axis using the virtual rectangle surface, the length and width of the virtual rectangle surface is increased or decreased to intersect the identified parallel visible surfaces along other axes. This helps make sure a created surface does not extend beyond the maximum dimension amount along axis to which it is parallel. The virtual rectangle surface may need to be moved along a perpendicular axis if the rectangle is away from the actual object.

At step 1440, augmented reality system 140 may identify the edges of a visible surface of the object. The augmented reality system may utilize audio/video analyzer module 412 to determine the edges of the surface using an image processing algorithm (e.g., Canny, Sobel edge detection algorithm).

At step 1450, augmented reality system 140 may calculate the distance between the identified edges of a surface. Calculating the distance between two edges may require drawing lines between two edges of the visible or virtual rectangle surface identified in step 1440 and are parallel to the axis associated with the surface (surface is parallel to the axis). The length of the lines between two edges of the visible surface along the X, Y, and Z axes identified in step 1450 are determined using a ruler application in applications 334 of FIG. 3A.

At step 1470, augmented reality system 140 may display the lines with longest length along X, Y, and Z-axes as dimensions of the object. For example, in customized user interface 802 length of FIGS. 8A and 8B, breadth and height of the inanimate object 810 are displayed along the X, Y, and Z axes relative to the objecting resting on the surface.

Although the previous systems are described in terms of a travel context, the system can be used for many different domains. The features used and data that is incorporated can be based on the specific domain in which the disclosed embodiments are deployed.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a hardware processor core of a computer, other programmable data processing apparatus, or other devices to function in a particular manner, such that the instructions stored in the computer readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer readable medium(s) may be utilized. The computer readable medium may be a non-transitory computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM, EEPROM or Flash memory), an optical fiber, a cloud storage, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, IR, etc., or any suitable combination of the foregoing.

Computer program code for carrying out operations for example embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate examples of the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. A non-transitory computer readable storage medium storing instructions that are executable by an augmented reality system that includes one or more processors to cause the augmented reality system to perform a method for providing a customizable user interface, the method comprising:
providing a user interface in a field of view of an augmented reality device of the augmented reality system, wherein the augmented reality device is worn by a user;
accessing a data set to populate the user interface based on a person being visible in the field of view of the augmented reality device, wherein the data set includes one or more trigger word sequences presented alongside the field of view;
capturing audio from the user of the augmented reality device of the augmented reality system;
determining whether the captured audio includes a trigger word sequence of the one or more trigger word sequences presented alongside the field of view;
identifying an action element mapped to the trigger word sequence based on the determination; and
updating the user interface based on the identified action element.

2. (canceled)

3. The non-transitory computer readable storage medium of claim 1, wherein accessing the data set to populate the user interface further comprises:
parsing the captured audio to identify a trigger word sequence.

4. The non-transitory computer readable storage medium of claim 1, wherein accessing the data set to populate the user interface further comprises:
parsing of the captured audio to identify a trigger word sequence by converting the captured audio to text; and
determining whether the captured audio includes the trigger word sequence of the one or more trigger word sequences further comprises determining whether a match exists between one or more words in the converted text and one or more words of the trigger word sequence.

5. (canceled)

6. (canceled)

7. The non-transitory computer readable storage medium of claim 1, wherein updating the user interface based on the identified action element further comprises:
querying one or more data sources associated with the action element;
populating the data set based on results of the queried one or more data sources.

8. (canceled)

9. The non-transitory computer readable storage medium of claim 1, wherein the instructions that are executable by an augmented reality system that includes one or more processors to cause the augmented reality system to further perform:
determining an identity of the person in the field of view of the augmented reality device; and
finding the data set based on the identity of the person.

10. The non-transitory computer readable storage medium of claim 9, wherein the instructions that are executable by the augmented reality system cause the augmented reality system to further perform:
accessing historical information of the person based on determined identification.

11. The non-transitory computer readable storage medium of claim 10, wherein the historical information of the person further comprises:
travel history of the person.

12. (canceled)

13. The non-transitory computer readable storage medium of claim 1, wherein the instructions that are executable by the augmented reality system cause the augmented reality system to further perform:
determining mood of the person in the field of view of the augmented reality system.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. An augmented reality system with a customizable user interface comprising:
a memory;
an augmented reality device configured to be worn by a user; and
one or more processors configured to cause the augmented reality system to:
provide a user interface in a field of view of the augmented reality device;
access a data set to populate the user interface based on a person being visible in the field of view of the augmented reality device, wherein the data set includes one or more trigger word sequences presented alongside the field of view;
capture audio from the user of the augmented reality device of the augmented reality system;
determine whether the captured audio includes a trigger word sequence of the one or more trigger word sequences presented alongside the field of view;
identify an action element mapped to a trigger word sequence based on the determination; and
update the user interface based on the identified action element.

32. (canceled)

33. The augmented reality system of claim 31, wherein access the data set to populate the user interface further comprises:
parse the captured audio to identify a trigger word sequence.

34. The augmented reality system of claim 33, wherein:
parse of the captured audio to identify a trigger word sequence further comprises convert the captured audio to text; and
determine whether the captured audio includes the trigger word sequence of the one or more trigger word sequences further comprises determine whether a match exists between one or more words in the converted text and one or more words of the trigger word sequence.

35. The augmented reality system of claim 31, wherein update the user interface based on the identified action element further comprises:
query one or more data sources associated with the action element;
populate the data set based on results of the queried one or more data sources.

36. (canceled)

37. The augmented reality system of claim 31, wherein the one or more processors are configured to cause the augmented reality system to:
determine an identity of the person in the field of view of the augmented reality device; and
finding the data set based on the identity of the person.

38. The augmented reality system of claim 31, wherein the one or more processors configured to cause the augmented reality system to:
determine mood of the person in the field of view of the augmented reality system.

39. (canceled)

40. (canceled)

41. (canceled)

42. (canceled)

43. (canceled)

44. (canceled)

45. (canceled)

46. (canceled)

47. (canceled)

48. A method performed by an augmented reality system for providing a customizable user interface, the method comprising:
providing a user interface in a field of view of an augmented reality device of the augmented reality system, wherein the augmented reality device is worn by a user;
accessing a data set to populate the user interface based on a person being visible in the field of view of the augmented reality device, wherein the data set includes one or more trigger word sequences presented alongside the field of view;
capturing audio from the user of the augmented reality device of the augmented reality system;
determining whether the captured audio includes a trigger word sequence of the one or more trigger word sequences presented alongside the field of view;
identifying an action element mapped to a trigger word sequence based on the determination; and
updating the user interface based on the identified action element.

49. (canceled)

50. The method of claim 48, wherein accessing the data set to populate the user interface further comprises:
parsing the captured audio to identify a trigger word sequence.

51. The method of claim 48, wherein accessing the data set to populate the user interface further comprises:
parsing of the captured audio to identify a trigger word sequence by converting the captured audio to text; and
determining whether the captured audio includes the trigger word sequence of the one or more trigger word sequences further comprises determining whether a match exists between one or more words in the converted text and one or more words of the trigger word sequence.

52. The method of claim 48, wherein updating the user interface based on the identified action element further comprises:
querying one or more data sources associated with the action element;
populating the data set based on results of the queried one or more data sources.

53. (canceled)

54. The method of claim 48, further comprising:
determining an identity of the person in the field of view of the augmented reality device; and
finding the data set based on the identity of the person.

55. The method of claim 48, further comprising:
determining mood of the person in the field of view of the augmented reality system.

56. (canceled)

57. (canceled)

58. (canceled)

59. (canceled)

60. (canceled)

61. (canceled)

62. (canceled)

63. (canceled)

64. (canceled)
